(19) United States
(12) Patent Application Publication
(10) Pub. No.: US 2018/0302944 A1
(43) Pub. Date: Oct. 18, 2018

(54) Data Transmission Processing Method, User Equipment, and Base Station

(71) Applicant: Huawei Technologies Co., Ltd., Shenzhen (CN)

(72) Inventors: Junren Chang, Beijing (CN); Shulan Feng, Beijing (CN); Jinhuan Xia, Beijing (CN); Xiaodong Yang, Shenzhen (CN); Yongqiang Gao, Beijing (CN); Wei Quan, Beijing (CN)

(21) Appl. No.: 16/015,759

(22) Filed: Jun. 22, 2018

Related U.S. Application Data
(63) Continuation of application No. PCT/CN2015/098332, filed on Dec. 22, 2015.

(51) Int. Cl. H04W 76/19; H04W 36/00

(52) U.S. Cl. CPC H04W 76/19; H04W 36/0033

(57) ABSTRACT

The present disclosure provides a data transmission processing method, including: receiving context information saving indication information sent by a base station, and saving context information of user equipment according to the context information saving indication information; determining that the user equipment is in a state related to triggering of RRC connection re-establishment or triggering of RRC connection establishment; and triggering an RRC connection re-establishment process or an RRC connection establishment process when the user equipment has uplink and/or downlink to-be-transmitted data, and transmit the uplink and/or downlink to-be-transmitted data on a re-established RRC connection or an established RRC connection using the context information of the user equipment.

### CROSS-REFERENCE TO RELATED APPLICATIONS

This application is a continuation of International Application No. PCT/CN2015/098332, filed on Dec. 22, 2015, the disclosure of which is hereby incorporated by reference in its entirety.

### TECHNICAL FIELD

Embodiments of the present disclosure relate to the field of communications technologies, and in particular, to a data transmission processing method, user equipment, and a base station.

### BACKGROUND

In a current Long Term Evolution (LTE) system, user equipment (UE) is usually in an idle mode when no service needs to be transmitted. When a service needs to be transmitted, the UE needs to change into a connected mode from the idle mode before performing service transmission.

Each time when the UE has data that needs to be transmitted, the UE may need to perform massive procedures of message exchange with network-side devices, to be connected to an LTE system to transmit data. The network-side devices typically include an access network device, for example, a base station such as an evolved NodeB (eNB), and core network devices such as a mobility management entity (MME) and a serving gateway (SGW). To reduce overhead of message signaling in the foregoing message exchange procedures, and in particular, radio resource control (RRC) signaling, access-layer context information (referred to as context information below), and in particular, some UE-specific access-layer parameters, may be saved in the UE or the eNB.

Currently, context information saving and data transmission resumption of UE may be controlled by introducing a new RRC connection suspension procedure and a new RRC connection resumption procedure. In brief, the control process may include the following. When a time in which the UE has no data that needs to be transmitted reaches a specified time, an eNB performs a processing process of suspending an RRC connection of the UE, including message exchange between the eNB, an MME, and an SGW, so as to de-activate context information of the UE and release a radio bearer of the UE. Then, the eNB may send an RRC connection suspension message to the UE, to instruct the UE to save related context information. In addition, the RRC connection suspension message may also include a piece of flag information for context information resumption. After a period of time, if the UE has uplink or downlink data that needs to be transmitted, an RRC connection resumption process may need to be performed. The resumption process may include not only a random access process, but also interaction processes such as sending, by the UE to the eNB, an RRC connection resumption request that may carry parameters such as an authentication token (Auth token), a bearer identifier (Bearer ID), and an establishment cause (establ cause) of the UE and flag identification information providing a previous network configuration, and feeding back, by the eNB to the UE, an RRC connection resumption message carrying bearer description information (Bearer description) and a bearer identifier, to instruct the UE to resume data transmission. Implementation of the RRC connection resumption process may require, especially for the UE, design of a new interaction procedure or addition of an interaction procedure to the existing LTE related processing procedure. This process may be incompatible with the existing LTE procedure. Consequently, resumption of data transmission may be slow and relatively complex to implement.

### SUMMARY

Embodiments of the present disclosure provide a data transmission processing method, user equipment, and a base station, to quickly and easily resume data transmission of UE using context information of the UE.

A first aspect of the present disclosure provides a data transmission processing method, where the method may be executed by user equipment served by a base station. The method may include: receiving context information saving indication information sent by the base station, and saving context information of the user equipment according to the context information saving indication information. The method may also include determining that the user equipment is in a state related to triggering of radio resource control (RRC) connection re-establishment or triggering of RRC connection establishment. The method may also include triggering an RRC connection re-establishment process or an RRC connection establishment process when the user equipment has uplink and/or downlink to-be-transmitted data, to transmit the to-be-transmitted data using the saved context information and a re-established RRC connection or an established RRC connection.

With reference to the first aspect, in a first possible implementation of the first aspect, the determining that the user equipment is in a state related to triggering of RRC connection re-establishment or triggering of RRC connection establishment may include: determining that the user equipment is in a radio link failure RLF state.

With reference to the first aspect, in a second possible implementation of the first aspect, the determining that the user equipment is in a state related to triggering of RRC connection re-establishment or triggering of RRC connection establishment may include: determining that the user equipment is in a state of being timing synchronized with the base station; and when the user equipment has the to-be-transmitted data, determining that the user equipment is in an RLF state.

With reference to the first aspect, in a third possible implementation of the first aspect, the determining that the user equipment is in a state related to triggering of RRC connection re-establishment or triggering of RRC connection establishment may include: determining that the user equipment is in an RRC connection re-establishment initialization state and performing a cell selection or re-selection process based on the RRC connection re-establishment initialization state.

With reference to the first aspect, in a fourth possible implementation of the first aspect, the determining that the user equipment is in a state related to triggering of RRC connection re-establishment or triggering of RRC connection establishment may include: determining that the user equipment is in an RRC connection establishment initialization state and performing a cell selection or re-selection process based on the RRC connection establishment initialization state, or determining that the user equipment is in a cell selection or re-selection process.

With reference to the first or second possible implementation of the first aspect, in a fifth possible implementation of the first aspect, the triggering an RRC connection re-establishment process or an RRC connection establishment process when the user equipment has uplink and/or downlink to-be-transmitted data may include: determining whether a current serving cell of the user equipment meets a preset communication requirement; and if the current serving cell meets the preset communication requirement, when the user equipment has the to-be-transmitted data, sending an RRC connection re-establishment request or an RRC connection establishment request to the base station using the current serving cell; or if the current serving cell does not meet the preset communication requirement, performing a cell selection or re-selection process. The triggering may also include: when a base station corresponding to a selected cell is the base station and the user equipment has the to-be-transmitted data, sending an RRC connection re-establishment request or an RRC connection establishment request to the base station using the selected cell.

With reference to the third possible implementation of the first aspect, in a sixth possible implementation of the first aspect, the triggering an RRC connection re-establishment process or an RRC connection establishment process when the user equipment has uplink and/or downlink to-be-transmitted data may include: when the user equipment has the to-be-transmitted data, sending an RRC connection re-establishment request to the base station using a selected cell.

With reference to the fourth possible implementation of the first aspect, in a seventh possible implementation of the first aspect, the triggering an RRC connection re-establishment process or an RRC connection establishment process when the user equipment has uplink and/or downlink to-be-transmitted data may include: when the user equipment has the to-be-transmitted data, sending an RRC connection establishment request to the base station using a selected cell.

With reference to any one of the first aspect to the seventh possible implementation of the first aspect, in an eighth possible implementation of the first aspect, before the triggering an RRC connection re-establishment process or an RRC connection establishment process when the user equipment has uplink and/or downlink to-be-transmitted data, the method further may include: starting a first timer, and after the first timer expires, releasing the context information.

With reference to the eighth possible implementation of the first aspect, in a ninth possible implementation of the first aspect, the starting a first timer, and after the first timer expires, releasing the context information may include: performing a cell selection or re-selection process within a time period corresponding to the first timer, and selecting a cell; and if no cell is selected within the time period corresponding to the first timer, releasing the context information.

With reference to any one of the third to the ninth possible implementations of the first aspect, in a tenth possible implementation of the first aspect, the performing a cell selection or re-selection process may include: starting a second timer, and within an i^{th} time period corresponding to the second timer, suspending or stopping the second timer if a first cell is selected; and after the second timer is suspended or stopped, if the first cell is no longer a proper cell, resetting and restarting the second timer, and selecting a second cell within an (i+1-n)^{th} time period, where i is an integer ranging from 1 to n, and n is an integer greater than 1.

With reference to any one of the fifth to the tenth possible implementations of the first aspect, in an eleventh possible implementation of the first aspect, the sending an RRC connection re-establishment request to the base station may include: obtaining uplink timing advance information and/or an uplink transmission resource; and adjusting uplink transmit timing based on the uplink timing advance information, and/or sending an RRC connection re-establishment request to the base station using the uplink transmission resource. The RRC connection re-establishment request may include any one of identification information of the user equipment, a short message authentication code for integrity short MAC-I, and re-establishment cause indication information, and the re-establishment cause indication information may be used to instruct the user equipment to resume data transmission using the saved context information.

With reference to the eleventh possible implementation of the first aspect, in a twelfth possible implementation of the first aspect, the method further may include: receiving an RRC connection re-establishment message sent by the base station, where the connection re-establishment message may include radio resource configuration information and security key information; and performing corresponding resource configuration based on the radio resource configuration information, and determining to restore a data radio bearer DRB.

With reference to the twelfth possible implementation of the first aspect, in a thirteenth possible implementation of the first aspect, the method may further include: sending, to the base station, an RRC connection re-establishment complete message encrypted based on the security key information, where the RRC connection re-establishment complete message may include the to-be-transmitted data.

With reference to any one of the third to the thirteenth possible implementations of the first aspect, in a fourteenth possible implementation of the first aspect, the method may further include: if it is determined that the user equipment is in the RRC connection re-establishment initialization state, when the user equipment has the to-be-transmitted data or the user equipment sends the RRC connection re-establishment request to the base station, starting a third timer, and stopping the first timer and/or the second timer.

With reference to the fourteenth possible implementation of the first aspect, in a fifteenth possible implementation of the first aspect, the method may further include: if the RRC connection re-establishment message is received within a time period corresponding to the third timer, stopping recording time of the third timer; or if the RRC connection re-establishment message is not received within a time period corresponding to the third timer, performing one or more of the following operations: entering an RRC idle state; stopping the first timer; triggering sending of an RRC connection establishment request to the base station corresponding to the cell; and triggering cell selection or re-selection, and sending an RRC connection establishment request to the base station corresponding to the selected cell.

With reference to any one of the first aspect to the tenth possible implementation of the first aspect, in a sixteenth possible implementation of the first aspect, the triggering an RRC connection establishment process when the user equipment has uplink and/or downlink to-be-transmitted data may include: obtaining uplink timing advance information and/or an uplink transmission resource; and adjusting uplink transmit timing based on the uplink timing advance information, and/or sending an RRC connection establishment request to the base station using the uplink transmission resource, where the RRC connection establishment request may include identification information of the user equipment.

With reference to the sixteenth possible implementation of the first aspect, in a seventeenth possible implementation of the first aspect, the method further may include: receiving an RRC connection establishment message sent by the base station, where the RRC connection establishment message may include resumption indication information, and the resumption indication information may be used to instruct the user equipment to resume data transmission using the saved context information; and sending an RRC connection establishment complete message to the base station.

With reference to the seventeenth possible implementation of the first aspect, in an eighteenth possible implementation of the first aspect, the sending an RRC connection establishment complete message to the base station may include: sending the RRC connection establishment complete message to the base station, where the RRC connection establishment complete message may include a short MAC-I calculated based on the identification information of the user equipment; and/or obtaining a security key; and encrypting and/or applying integrity protection on the RRC connection establishment complete message based on the security key, and sending the RRC connection establishment complete message.

With reference to the sixteenth possible implementation of the first aspect, in a nineteenth possible implementation of the first aspect, the sending an RRC connection establishment request to the base station may include: obtaining a security key; and encrypting and/or applying integrity protection on the RRC connection establishment request based on the security key, and sending the RRC connection establishment request.

With reference to the eighteenth or nineteenth possible implementation of the first aspect, in a twentieth possible implementation of the first aspect, the obtaining a security key may include: obtaining a security key in the context information, where the security key may include a message integrity protection key K_{RRCinc}, a message encryption key K_{RRCenc}, and a data encryption key K_{UPenc}; or the obtaining a security key may include: receiving security key indication information sent by the base station, where the security key indication information may include security key update information. The method may also include: updating an intermediate key KeNB based on the security key update information, generating a message integrity protection key K_{RRCinc} based on an updated intermediate key KeNB and an integrity protection algorithm. The method may also include: generating a message encryption key K_{RRCenc} and a data encryption key K_{UPenc} based on the updated intermediate key KeNB and an encryption algorithm, where the security key indication information may be carried in any one of the following messages: a key update indication message, a data transmission indication message, an RRC connection establishment message, and a message carrying the UE context saving indication information.

With reference to the eleventh or sixteenth possible implementation of the first aspect, in a twenty-first possible implementation of the first aspect, the obtaining uplink timing advance information and/or an uplink transmission resource may include: determining whether a current coverage level has changed; and when the coverage level has changed, sending a random access request to the base station; and receiving a random access response message sent by the base station, where the random access response message may include the uplink timing advance information and uplink resource allocation information used to obtain the uplink transmission resource.

With reference to the twenty-first possible implementation of the first aspect, in a twenty-second possible implementation of the first aspect, the method may further include: when the coverage level has not changed, obtaining currently locally saved uplink timing advance information as the uplink timing advance information, where the uplink transmission resource may be obtained in any one of the following manners: sending a scheduling request resource to the base station; contending for an uplink shared channel resource; and obtaining a resource preconfigured for the user equipment by the base station.

With reference to any one of the first aspect to the twenty-second possible implementation of the first aspect, in a twenty-third possible implementation of the first aspect, the method further may include: when it is determined that no data needs to be transmitted within a first preset time, sending a context information saving request to the base station, to cause the base station to save the context information.

With reference to any one of the first aspect to the twenty-third possible implementation of the first aspect, in a twenty-fourth possible implementation of the first aspect, the context information saving indication information may be sent by the base station based on the context information saving request, or may be sent by the base station based on a record of data transmission with the user equipment when it is determined that no data transmission is performed with the user equipment within a second preset time, where the second preset time is equal to or not equal to the first preset time.

With reference to any one of the first aspect to the twenty-fourth possible implementation of the first aspect, in a twenty-fifth possible implementation of the first aspect, the method may further include: receiving configuration information of a fourth timer sent by the base station, where the fourth timer may be configured to time validity of a security key in the context information; and starting the fourth timer when the context information saving indication information is received.

With reference to any one of the first aspect to the twenty-fifth possible implementation of the first aspect, in a twenty-sixth possible implementation of the first aspect, the context information saving indication information may be included in any one of the following indication messages: a context information saving indication message, an RRC connection suspension indication message, and an RRC connection release indication message.

With reference to any one of the first aspect to the twenty-sixth possible implementation of the first aspect, in a twenty-seventh possible implementation of the first aspect, before the triggering an RRC connection re-establishment process or an RRC connection establishment process when the user equipment has uplink and/or downlink to-be-transmitted data, the method may further include: performing a cell selection or re-selection process, and if a base station corresponding to a selected cell is different from the base station that sends the context information saving indication information, or a quantity of selected-cell changes is greater than or equal to a preset quantity, determining to trigger an initial RRC connection establishment process when the user equipment has the to-be-transmitted data.

With reference to any one of the first aspect to the twenty-seventh possible implementation of the first aspect, in a twenty-eighth possible implementation of the first aspect, before the triggering an RRC connection re-establishment process or an RRC connection establishment process when the user equipment has uplink and/or downlink to-be-transmitted data, the method may further include: performing a cell selection or re-selection process, triggering execution of a location update process when it is determined that a track area of a selected cell has changed, and establishing a data radio bearer with a new base station in the location update process.

With reference to the twenty-eighth possible implementation of the first aspect, in a twenty-ninth possible implementation of the first aspect, the method may further include: receiving, in the location update process or after location update is complete, context information saving indication information sent by the new base station.

A second aspect of the present disclosure provides a data transmission processing method. The method is executed by a base station serving user equipment. The method may include: determining whether user equipment has not performed data transmission within a preset time; and sending context information saving indication information to the user equipment when the user equipment has not performed data transmission within the preset time, so that the user equipment saves context information. The method may also include determining that the user equipment is in a state related to triggering of RRC connection re-establishment or triggering of RRC connection establishment. The method may also include triggering an RRC connection re-establishment process or an RRC connection establishment process when there is uplink and/or downlink to-be-transmitted data.

With reference to the second aspect, in a first possible implementation of the second aspect, the method further may include: sending timer configuration information to the user equipment when the user equipment has not performed data transmission within the preset time, where the timer configuration information may include timer configuration information indicating validity of a security key in the context information and timer configuration information indicating validity of the context information.

With reference to the second aspect, in a second possible implementation of the second aspect, the method may further include: receiving an RRC connection establishment request sent by the user equipment, where the RRC connection establishment request may include identification information of the user equipment, and the identification information of the user equipment may include an S-TMSI; and sending an RRC connection establishment message to the user equipment when it is determined, based on the S-TMSI sent in advance by a mobility management entity MME, that the context information is valid, where the RRC connection establishment message may include resumption indication information, and the resumption indication information may be used to instruct the user equipment to resume data transmission using the saved context information.

A third aspect of the present disclosure provides user equipment. The user equipment may include a receiving and saving module, configured to: receive context information saving indication information sent by a base station, and save context information of the user equipment according to the context information saving indication information. The user equipment may also include: a determining module, configured to determine that the user equipment is in a state related to triggering of RRC connection re-establishment or triggering of RRC connection establishment. The user equipment may also include: a re-establishment processing module, configured to: trigger an RRC connection re-establishment process or an RRC connection establishment process when the user equipment has uplink and/or downlink to-be-transmitted data, to transmit the to-be-transmitted data using the saved context information and a re-established RRC connection or an established RRC connection.

With reference to the third aspect, in a first possible implementation of the third aspect, the determining module may include: a first determining submodule, configured to determine that the user equipment is in a radio link failure RLF state.

With reference to the third aspect, in a second possible implementation of the third aspect, the determining module may include: a second determining submodule, configured to determine that the user equipment is in a state of being timing synchronized with the base station; and a third determining submodule, configured to: when the user equipment has the to-be-transmitted data, determine that the user equipment is in an RLF state.

With reference to the third aspect, in a third possible implementation of the third aspect, the determining module may include: a fourth determining submodule, configured to: determine that the user equipment is in an RRC connection re-establishment initialization state, and perform a cell selection or re-selection process based on the RRC connection re-establishment initialization state.

With reference to the third aspect, in a fourth possible implementation of the third aspect, the determining module may include: a fifth determining submodule, configured to: determine that the user equipment is in an RRC connection establishment initialization state and perform a cell selection or re-selection process based on the RRC connection establishment initialization state, or determine that the user equipment is in a cell selection or re-selection process.

With reference to any one of the first to the fourth possible implementations of the third aspect, in a fifth possible implementation of the third aspect, the re-establishment processing module may further include: a judgment submodule, configured to determine whether a current serving cell of the user equipment meets a preset communication requirement; a sending submodule, configured to: if the current serving cell meets the preset communication requirement, send an RRC connection re-establishment request or an RRC connection establishment request to the base station. The re-establishment processing module may further include: a selection submodule, configured to: if the current serving cell does not meet the preset communication requirement, perform a cell selection or re-selection process, where the sending submodule may be further configured to: send an RRC connection re-establishment request or an RRC connection establishment request to the base station when a cell is selected and a base station corresponding to the cell is the base station.

With reference to the fifth possible implementation of the third aspect, in a sixth possible implementation of the third aspect, the sending submodule may be further configured to: when the user equipment has the to-be-transmitted data, send an RRC connection re-establishment request to the base station using a selected cell.

With reference to the fifth possible implementation of the third aspect, in a seventh possible implementation of the third aspect, the sending submodule may be further configured to: when the user equipment has the to-be-transmitted data, send an RRC connection establishment request to the base station using a selected cell.

With reference to any one of the third aspect to the seventh possible implementation of the third aspect, in an eighth possible implementation of the third aspect, the re-establishment processing module may further include: a timing control submodule, configured to: start a first timer, and after the first timer expires, release the context information.

With reference to the eighth possible implementation of the third aspect, in a ninth possible implementation of the third aspect, the selection submodule may be configured to: perform a cell selection or re-selection process within a time period corresponding to the first timer, and select a cell; and the timing control submodule may be configured to: if no cell is selected within the time period corresponding to the first timer, release the context information.

With reference to any one of the fifth to the ninth possible implementations of the third aspect, in a tenth possible implementation of the third aspect, the selection submodule may be configured to: start a second timer, and within an i^{th} time period corresponding to the second timer, suspend or stop the second timer if a first cell is selected; and after the second timer is suspended or stopped, if the first cell is no longer a proper cell, reset and restart the second timer, and select a second cell within an (i+i-n)^{th} time period, where i is an integer ranging from 1 to n, and n is an integer greater than 1.

With reference to any one of the third aspect to the tenth possible implementation of the third aspect, in an eleventh possible implementation of the third aspect, the re-establishment processing module may include: a first obtaining submodule, configured to obtain uplink timing advance information and/or an uplink transmission resource, where the sending submodule may be configured to: adjust uplink transmit timing based on the uplink timing advance information, and/or send an RRC connection re-establishment request to the base station using the uplink transmission resource, where the RRC connection re-establishment request may include any one of: identification information of the user equipment, a short message authentication code for integrity short MAC-I, and re-establishment cause indication information. The re-establishment cause indication information may be used to instruct the user equipment to resume data transmission using the saved context information.

With reference to the eleventh possible implementation of the third aspect, in a twelfth possible implementation of the third aspect, the re-establishment processing module may further include: a receiving submodule, configured to receive an RRC connection re-establishment message sent by the base station, where the connection re-establishment message may include radio resource configuration information and security key information; and a configuration submodule, configured to: perform corresponding resource configuration based on the radio resource configuration information, and determine to restore a data radio bearer DRB.

With reference to the twelfth possible implementation of the third aspect, in a thirteenth possible implementation of the third aspect, the sending submodule may be further configured to send, to the base station, an RRC connection re-establishment complete message encrypted based on the security key information, where the RRC connection re-establishment complete message may include the to-be-transmitted data. The sending submodule may be further configured to send, to the base station, an RRC connection re-establishment complete message encrypted based on the security key information, where the RRC connection re-establishment complete message may include the to-be-transmitted data.

With reference to any one of the eighth to the thirteenth possible implementations of the third aspect, in a fourteenth possible implementation of the third aspect, the timing control submodule may be further configured to: if it is determined that the user equipment is in the RRC connection re-establishment initialization state, when the user equipment has the to-be-transmitted data or the user equipment sends the RRC connection re-establishment request to the base station, start a third timer, and stop the first timer and/or the second timer.

With reference to the fourteenth possible implementation of the third aspect, in a fifteenth possible implementation of the third aspect, the timing control submodule may be further configured to: if the receiving submodule receives the RRC connection re-establishment message within a time period corresponding to the third timer, stop recording time of the third timer. The timing control submodule may be further configured to: if the receiving submodule does not receive the RRC connection re-establishment message within a time period corresponding to the third timer, perform one or more of the following operations: entering an RRC idle state; stopping the first timer; triggering sending of an RRC connection establishment request to the base station corresponding to the cell; and triggering cell selection or re-selection, and sending an RRC connection establishment request to the base station corresponding to the selected cell.

With reference to any one of the third aspect to the tenth possible implementation of the third aspect, in a sixteenth possible implementation of the third aspect, the re-establishment processing module may include: a second obtaining submodule, configured to obtain uplink timing advance information and/or an uplink transmission resource, where the sending submodule may be further configured to: adjust uplink transmit timing based on the uplink timing advance information, and/or send an RRC connection establishment request to the base station using the uplink transmission resource, where the RRC connection establishment request may include identification information of the user equipment.

With reference to the sixteenth possible implementation of the third aspect, in a seventeenth possible implementation of the third aspect, the receiving submodule may be further configured to: receive an RRC connection establishment message sent by the base station, where the RRC connection establishment message may include resumption indication information, and the resumption indication information may be used to instruct the user equipment to resume data transmission using the saved context information; and the sending submodule may be further configured to send an RRC connection establishment complete message to the base station.

With reference to the seventeenth possible implementation of the third aspect, in an eighteenth possible implementation of the third aspect, the sending submodule may be further configured to send an RRC connection establishment complete message to the base station, where the RRC connection establishment complete message may include a short MAC-I calculated based on the identification information of the user equipment; and/or the re-establishment processing module may further include: a third obtaining submodule, configured to obtain a security key, where the sending submodule may be further configured to: encrypt and/or apply integrity protection on the RRC connection establishment complete message based on the security key, and send the RRC connection establishment complete message.

With reference to the eighteenth possible implementation of the third aspect, in a nineteenth possible implementation of the third aspect, the sending submodule may be further configured to: encrypt and/or apply integrity protection on the RRC connection establishment request according to the security key, and send the RRC connection establishment request.

With reference to the eighteenth possible implementation of the third aspect, in a twentieth possible implementation of the third aspect, the third obtaining submodule may be configured to: obtain a security key in the context information, where the security key may include a message integrity protection key K_{RRCinc}, a message encryption key K_{RRCenc}, and a data encryption key K_{UPene}; or the receiving submodule may be further configured to receive security key indication information sent by the base station, where the security key indication information may include security key update information. The re-establishment processing module may further include: an update submodule, configured to update an intermediate key KeNB based on the security key update information; and a calculation submodule, configured to: generate a message integrity protection key K_{RRCinc} based on an updated intermediate key KeNB and an integrity protection algorithm, and generate a message encryption key K_{RRCenc} and a data encryption key K_{UPenc} based on the updated intermediate key KeNB and an encryption algorithm, where the security key indication information may be carried in any one of the following messages: a key update indication message, a data transmission indication message, an RRC connection establishment message, and a message carrying the UE context saving indication information.

With reference to any one of the eleventh to the sixteenth possible implementations of the third aspect, in a twenty-first possible implementation of the third aspect, the first obtaining submodule or the second obtaining submodule may include: a judgment unit, configured to determine whether a current coverage level has changed; and a first obtaining unit, configured to: when the coverage level has changed, send a random access request to the base station; and receive a random access response message sent by the base station. The random access response message may include the uplink timing advance information and uplink resource allocation information may be used to obtain the uplink transmission resource.

With reference to the twenty-first possible implementation of the third aspect, in a twenty-second possible implementation of the third aspect, the first obtaining submodule or the second obtaining submodule module may further include: a second obtaining unit, configured to: when the coverage level has not changed, obtain currently locally saved uplink timing advance information as the uplink timing advance information, where the uplink transmission resource may be obtained in any one of the following manners: sending a scheduling request resource to the base station; contending for an uplink shared channel resource; and obtaining a resource preconfigured for the user equipment by the base station.

With reference to any one of the third aspect to the twenty-second possible implementation of the third aspect, in a twenty-third possible implementation of the third aspect, the method may further include: a sending module, configured to: when it is determined that no data needs to be transmitted within a first preset time, send a context information saving request to the base station, to cause the base station to save the context information.

With reference to any one of the third aspect to the twenty-third possible implementation of the third aspect, in a twenty-fourth possible implementation of the third aspect, the context information saving indication information may be sent by the base station based on the context information saving request, or may be sent by the base station based on a record of data transmission with the user equipment when it is determined that no data transmission is performed with the user equipment within a second preset time. The second preset time is equal to or not equal to the first preset time.

With reference to any one of the third aspect to the twenty-fourth possible implementation of the third aspect, in a twenty-fifth possible implementation of the third aspect, the receiving module may be further configured to: receive configuration information of a fourth timer sent by the base station, and start the fourth timer when receiving the context information saving indication information, where the fourth timer may be configured to time validity of a security key in the context information.

With reference to any one of the third aspect to the twenty-fifth possible implementation of the third aspect, in a twenty-sixth possible implementation of the third aspect, the context information saving indication information may be included in any one of the following indication messages: a context information saving indication message, an RRC connection suspension indication message, and an RRC connection release indication message.

With reference to any one of the third aspect to the twenty-sixth possible implementation of the third aspect, in a twenty-seventh possible implementation of the third aspect, the selection submodule may be further configured to: perform a cell selection or re-selection process, and if a base station corresponding to a selected cell is different from the base station that sends the context information saving indication information, or a quantity of selected-cell changes is greater than or equal to a preset quantity, determine to trigger an initial RRC connection establishment process when the user equipment has the to-be-transmitted data.

With reference to any one of the third aspect to the twenty-seventh possible implementation of the third aspect, in a twenty-eighth possible implementation of the third aspect, the selection submodule may be further configured to: perform a cell selection or re-selection process, trigger execution of a location update process when it is determined that a track area of a selected cell has changed, and establish a data radio bearer with a new base station in the location update process.

With reference to the twenty-eighth possible implementation of the third aspect, in a twenty-ninth possible implementation of the third aspect, the receiving and saving module may be further configured to: receive, in the location update process or after location update is complete, context information saving indication information sent by the new base station.

A fourth aspect of the present disclosure provides a base station. The base station may include: a determining module, configured to determine whether user equipment has not performed data transmission within a preset time. The base station may also include: a sending module, configured to: when the determining module determines that the user equipment has not performed data transmission within the preset time, send context information saving indication information to the user equipment, so that the user equipment saves context information. The sending module is also configured to determine that the user equipment is in a state related to triggering of RRC connection re-establishment or triggering of RRC connection establishment. The sending module is also configured to, when there is uplink and/or downlink to-be-transmitted data, trigger an RRC connection re-establishment process or an RRC connection establishment process.

With reference to the fourth aspect, in a first possible implementation of the fourth aspect, the sending module may be further configured to: sending timer configuration information to the user equipment when the determining module determines that the user equipment has not performed data transmission within the preset time, where the timer configuration information may include timer configuration information indicating validity of a security key in the context information and timer configuration information indicating validity of the context information.

With reference to the fourth aspect, in a second possible implementation of the fourth aspect, the base station may further include: a receiving module, configured to receive an RRC connection establishment request sent by the user equipment, where the RRC connection establishment request may include identification information of the user equipment, and the identification information of the user equipment may include an S-TMSI; and the sending module may be further configured to send an RRC connection establishment message to the user equipment when the determining module determines, based on the S-TMSI sent in advance by a mobility management entity MME, that the context information is valid, where the RRC connection establishment message may include resumption indication information, and the resumption indication information may be used to instruct the user equipment to resume data transmission using the saved context information.

According to the data transmission processing method, the user equipment, and the base station that are provided in the present disclosure, after the user equipment receives the context information saving indication message sent by the base station, the user equipment may be forcibly determined to be in the state related to triggering of RRC connection re-establishment or triggering of RRC connection establishment, for example, the RLF state. When there is the data that needs to be transmitted, the RRC connection re-establishment process or the RRC connection establishment process may be triggered immediately based on the state related to triggering, to quickly resume data transmission by reusing the RRC connection re-establishment process or the RRC connection establishment process. In addition, because the RRC connection re-establishment process or the RRC connection establishment process in an LTE specification is reused, the user equipment may not need to make a complex change, and may be easy to implement.

### BRIEF DESCRIPTION OF THE DRAWINGS

To describe the technical solutions in the embodiments of the present disclosure more clearly, the following briefly describes the accompanying drawings required for describing the embodiments. The accompanying drawings in the following description show some embodiments of the present disclosure, and persons of ordinary skill in the art may still derive other drawings from these accompanying drawings without creative efforts.

FIG. 1 is a flowchart of Embodiment 1 of a data transmission processing method according to an embodiment of the present disclosure;

FIG. 2 is a flowchart of a cell selection or re-selection process according to an embodiment of the present disclosure;

FIG. 3 is a flowchart of an RRC connection re-establishment process different from a cell selection or re-selection process according to an embodiment of the present disclosure;

FIG. 4 is a flowchart of a specific implementation of step 301;

FIG. 5 is a flowchart of an implementation of an RRC connection establishment process different from a cell selection or re-selection process according to an embodiment of the present disclosure;

FIG. 6A and FIG. 6B are a diagram of signaling interaction of Embodiment 2 of a data transmission processing method according to an embodiment of the present disclosure;

FIG. 7A and FIG. 7B are a diagram of signaling interaction of Embodiment 3 of a data transmission processing method according to an embodiment of the present disclosure;

FIG. 8A and FIG. 8B are a diagram of signaling interaction of Embodiment 4 of a data transmission processing method according to an embodiment of the present disclosure;

FIG. 9A and FIG. 9B are a diagram of signaling interaction of Embodiment 5 of a data transmission processing method according to an embodiment of the present disclosure;

FIG. 10 is a flowchart of Embodiment 6 of a data transmission processing method according to an embodiment of the present disclosure;

FIG. 11 is a schematic structural diagram of Embodiment 1 of user equipment according to an embodiment of the present disclosure;

FIG. 12 is a schematic structural diagram of Embodiment 2 of user equipment according to an embodiment of the present disclosure;

FIG. 13 is a schematic structural diagram of Embodiment 3 of user equipment according to an embodiment of the present disclosure;

FIG. 14 is a schematic structural diagram of Embodiment 4 of user equipment according to an embodiment of the present disclosure;

FIG. 15 is a schematic structural diagram of Embodiment 5 of user equipment according to an embodiment of the present disclosure;

FIG. 16 is a schematic structural diagram of Embodiment 1 of a base station according to an embodiment of the present disclosure; and

FIG. 17 is a schematic structural diagram of Embodiment 2 of a base station according to an embodiment of the present disclosure.

### DETAILED DESCRIPTION OF ILLUSTRATIVE EMBODIMENTS

To make the objectives, technical solutions, and advantages of the embodiments of the present disclosure clearer, the following describes the technical solutions in the embodiments of the present disclosure with reference to the accompanying drawings in the embodiments of the present disclosure. The described embodiments are some but not all of the embodiments of the present disclosure. All other embodiments obtained by persons of ordinary skill in the art based on the embodiments of the present disclosure without creative efforts shall fall within the protection scope of the present disclosure.

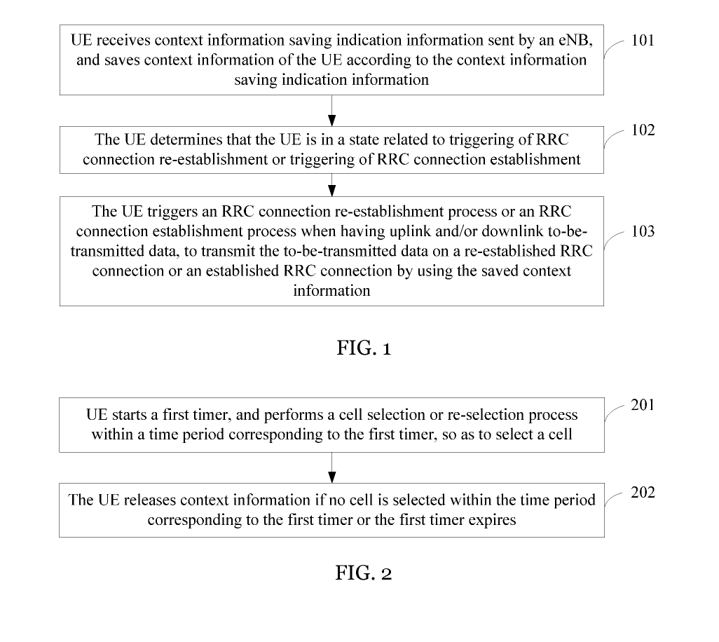

FIG. 1 is a flowchart of Embodiment 1 of a data transmission processing method according to an embodiment of the present disclosure. A solution of the present disclosure may be applied to an LTE network, and main related interacting network elements include UE, an eNB, and core network devices, for example, an MME and an SGW. The UE may be a UE in a current LTE system, or may be a UE in NarrowBand Internet Of Things (NB-IoT).

Currently, 3GPP has set up a new NB-IoT project. An objective of this project is to further extend an LTE system, so as to support massive low-throughput Internet of Things devices or massive Internet of Things devices insensitive to a delay requirement. Ultra-low complexity and ultra-low power consumption are two key requirements for such Internet of Things devices.

This embodiment is described in detail from a perspective of UE, that is, using UE as an entity to execute the method. As shown in FIG. 1, the data transmission processing method may include the following steps.

Step 101. The UE may receive context information saving indication information sent by the eNB, and may save context information of the UE according to the context information saving indication information.

Step 102. The UE may determine that the UE is in a state related to triggering of RRC connection re-establishment or triggering of RRC connection establishment.

Step 103. The UE may trigger an RRC connection re-establishment process or an RRC connection establishment process when having uplink and/or downlink to-be-transmitted data, to transmit the to-be-transmitted data using the saved context information and a re-established RRC connection or an established RRC connection.

In this embodiment, the context information saving indication information may be sent to the UE by the eNB when the eNB determines that the UE has not transmitted data within a specified time.

The eNB may use the following optional manners to determine that the UE has not transmitted data within the specified time.

Manner 1: In a process in which the UE performs data transmission with a network, if no subsequent data needs to be transmitted within a specified time after current transmission of a piece of data is complete, that is, when it is determined that no data needs to be transmitted within the preset time, the UE may send a context information saving request to the eNB, to cause the eNB to save the context information of the UE, that is, to request the eNB to save the context information of the UE. In this case, the context information saving indication information may be sent by the eNB based on the context information saving request. To be specific, when the eNB receives the context information saving request, the eNB determines that the UE has no subsequent data that needs to be transmitted within the time, and may send the context saving indication message to the UE. The context saving indication message may carry the context saving indication information.

It should be noted that saving the context information of the UE is saving the context information on a UE side and on a network side, to be specific, the eNB. In addition, during specific implementation, the context information saving request may alternatively be referred to as an RRC connection suspension request message, or the like. The context information saving indication message may alternatively be referred to as an RRC connection suspension indication message, an RRC connection release indication message, or the like. No specific limitation is imposed.

Manner 2: The context information saving indication information may be sent by the eNB based on a record of data transmission with the UE when it is determined that no data transmission is performed with the UE within a preset time. In this manner, when determining, depending on a status of data transmission with the UE, that the UE has no subsequent data that needs to be transmitted, the eNB may automatically determine that saving the context information of the UE (or equivalently referred to as RRC connection suspension or release) may be performed, so as to send the context information saving indication information to the UE.

It should be noted that after determining that the UE has not transmitted data within the specified time, the eNB may not immediately send the context saving indication information to the UE, but may need to interact with core network devices, an MME and an SGW, to complete related processing on the network side, for example, UE bearer suspension processing, and may send the context saving indication information to the UE after the related processing is complete. Interaction between the eNB and the core network devices is described in a subsequent embodiment, and details are not described in this embodiment.

Further, after receiving the context saving indication information sent by the eNB, the UE may save the context information. Generally, the context information may include one or more of: radio resource configuration information of the UE, a security algorithm, a UE identifier or the identification information of the UE, and measurement configuration information. The radio resource configuration information may include one or more of: physical layer configuration information, MAC layer configuration information, RLC layer configuration information, and PDCP layer configuration information.

In this embodiment, after saving the context information, the UE may immediately forcibly determine the UE to be in a state related to triggering of RRC connection re-establishment or triggering of RRC connection establishment, so as to ensure compatibility with a related processing procedure in an existing LTE specification and reduce UE implementation complexity.

The following several optional implementations may be used by the UE to determine that the UE is in the state related to triggering of RRC connection re-establishment or triggering of RRC connection establishment.

Manner 1: Determine that the UE is in a radio link failure (RLF) state.

Specifically, when the UE determines that the context information of the UE needs to be saved or determines that the UE needs to be in an RRC-suspended state, that is, when the context saving indication information sent by the eNB is received, the UE may determine that the UE is currently in the RLF state (or referred to as an extended RLF state or a virtual RLF state). The extended or virtual RLF state is intended to distinguish from a trigger cause of an existing RLF state. In this embodiment, the UE is not really in the RLF state at this time, but is forcibly set to the RLF state.

After the UE determines that the UE is in an RLF state, unlike that an RRC connection re-establishment process may be triggered immediately when the UE is really in an RLF state, in this embodiment, the UE may not immediately trigger an RRC connection re-establishment process, but may trigger the RRC connection re-establishment process when the UE has uplink and/or downlink to-be-transmitted data.

Because the UE is forcibly set to the RLF state at this time, rather than being in a real RLF state, RRC connection re-establishment is not triggered immediately, but triggering of RRC connection re-establishment may be deferred to when the UE has data that needs to be transmitted. In this way, when there is data that needs to be transmitted, data transmission may be quickly resumed using an existing RRC connection re-establishment process in LTE.

Manner 2: Determine that the UE is in a state of being timing synchronized with the eNB, and determining that the UE is in an RLF state when the UE has to-be-transmitted data.

Specifically, when determining that the context information of the UE needs to be saved or determining that the UE is in an RRC-suspended state, the UE may further determine that the UE is in a timing-synchronized state, to be specific, in a state of being timing synchronized with the eNB.

Specifically, the UE may start a timer at this time, and the UE may be determined to be in the timing-synchronized state within a time period corresponding to the timer. If the UE has the to-be-transmitted data that needs to be transmitted, the UE may immediately determine that the UE is in the RLF state and then may trigger an RRC connection re-establishment process.

In this manner, in a general normal process, the UE may detect whether the UE is timing synchronized with the eNB, and if timing synchronization is lost, may immediately trigger the RRC connection re-establishment process. The UE may be forcibly determined to be in the state of being timing synchronized with the eNB, and when there is data that needs to be transmitted, the UE may be forcibly determined to be in the RLF state, so as to trigger the RRC connection re-establishment process. In this way, when the UE has data that needs to be transmitted, data transmission can be quickly resumed by triggering an RLF event and reusing an existing RRC connection re-establishment process.

Manner 3: Determine that the UE is in an RRC connection re-establishment initialization state, and perform a cell selection or re-selection process based on the RRC connection re-establishment initialization state.

Specifically, when determining that the context information of the UE needs to be saved or determining that the UE is in an RRC-suspended state, the UE may determine that the UE is in the RRC connection re-establishment initialization state. To be specific, the UE may determine that an RRC connection re-establishment process needs to be triggered at this time. However, a process that may need to be performed immediately at this time may be the cell selection or re-selection process, to be specific, an initialization stage of the RRC connection re-establishment process. Alternatively, optionally, similar to manner 1, the UE first may determine to enter the RLF state (or referred to as an extended RLF state or a virtual RLF state), and then may determine to trigger an initialization stage of the RRC connection re-establishment process.

In this manner, although the UE may immediately trigger the RRC connection re-establishment process after saving the context information, the UE may first perform only the cell selection or re-selection process, but may not perform any other RRC connection re-establishment process, and may not trigger a subsequent RRC connection re-establishment processing process, for example, performing random access or sending an RRC connection re-establishment request to the eNB, until the UE has to-be-transmitted data that needs to be transmitted. It should be noted that, in this embodiment, the triggering an RRC connection re-establishment process is mainly sending the RRC connection re-establishment request to the eNB using a cell selected through the cell selection or re-selection process.

It can be noted that, in this embodiment, for ease of description, the RRC connection re-establishment process may be divided into an initialization process, namely, the cell selection or re-selection process, and another RRC connection re-establishment process different from the cell selection or re-selection process. Specific implementation of the two processes is described in detail in subsequent embodiments.

Manner 4: Determine that the UE is in an RRC connection establishment initialization state and perform a cell selection or re-selection process based on the RRC connection establishment initialization state, or determine that the UE is in a cell selection or re-selection process.

Specifically, when determining that the context information of the UE needs to be saved or determining that the UE is in an RRC-suspended state, the UE may determine that the UE is in the RRC connection establishment initialization state. To be specific, the UE may determine that an RRC connection establishment process needs to be triggered at this time. However, a process that may need to be performed immediately at this time may be the cell selection or re-selection process.

In this manner, although the UE may immediately trigger the RRC connection establishment process after saving the context information, the UE may first perform only the cell selection or re-selection process, but may not perform any other RRC connection establishment process, and may not trigger a subsequent RRC connection establishment processing process, for example, performing random access or sending an RRC connection establishment request to the eNB, until the UE has to-be-transmitted data that needs to be transmitted. It should be noted that, in this embodiment, the triggering an RRC connection establishment process is mainly sending an RRC connection establishment request to the eNB using a cell selected through the cell selection or re-selection process. In addition, it should be noted that after sending the RRC connection establishment request, the UE may release the saved context information.

It can be understood that, in this embodiment, for ease of description, the RRC connection establishment process may be divided into an initialization process, namely, the cell selection or re-selection process, and another RRC connection establishment process different from the cell selection or re-selection process. Specific implementation of the two processes is described in detail in subsequent embodiments.

In this embodiment, after the UE may determine the UE to be in a triggering state, in any one of the foregoing optional manners, related to triggering of RRC connection re-establishment or triggering of RRC connection establishment, when the UE has the to-be-transmitted data that needs to be transmitted, a corresponding processing process may be triggered. Specifically, for manner 1 and manner 2, when it is determined that the UE is in the RLF state and there is the to-be-transmitted data, the cell selection or re-selection process and the another RRC connection re-establishment process or the another RRC connection establishment process, that is, an entire RRC connection re-establishment process or an entire RRC connection establishment process, may be triggered. For manner 3, if it is determined that the UE is in the RRC connection re-establishment initialization state, after the cell selection or re-selection process is performed, another RRC connection re-establishment process may be performed when there is the to-be-transmitted data, that is, the another RRC connection re-establishment process different from the cell selection or re-selection process may be triggered. To be specific, the RRC connection re-establishment request may be sent to the eNB. For manner 4, if it is determined that the UE is in the RRC connection establishment initialization state, after the cell selection or re-selection process is performed, the another RRC connection establishment process may be performed when there is the to-be-transmitted data, that is, the another RRC connection establishment process different from the cell selection or re-selection process may be triggered. To be specific, the RRC connection establishment request may be sent to the eNB.

Specifically, the UE may use the following optional manner to determine whether there is uplink or downlink to-be-transmitted data: when determining, according to an indication of an application layer, that there is uplink data arriving or the UE has uplink data that needs to be sent, determining, by the UE, that there is uplink to-be-transmitted data; or when receiving a data transmission notification message sent by the eNB, determining, by the UE, that there is downlink data that needs to be received, to determine that there is downlink to-be-transmitted data.

The data transmission notification message may be, for example, a paging message.

To sum up, for manner 1, after saving context according to the context information saving indication information of the eNB, the UE may determine that the UE is in the RLF state, and may defer triggering of the RRC connection re-establishment process to when there is the to-be-transmitted data, so as to quickly resume data transmission by reusing the RRC connection re-establishment process.

For manner 2, after saving context according to the context information saving indication information of the eNB, the UE may determine that the UE is in the state of being timing synchronized with the eNB, and may defer, to when there is the to-be-transmitted data, triggering of the RRC connection re-establishment process immediately when it is determined that the UE is in the RLF state, so as to quickly resume data transmission by reusing the RRC connection re-establishment process.

For manner 3, after saving context according to the context information saving indication information of the eNB, the UE may determine to defer triggering of the cell selection or re-selection process immediately when the UE is in the RRC connection re-establishment initialization state, to triggering of the subsequent RRC connection re-establishment process immediately when there is the to-be-transmitted data, so as to quickly resume data transmission by reusing the RRC connection re-establishment process.

For manner 4, after saving context according to the context information saving indication information of the eNB, the UE may determine to defer triggering of the cell selection or re-selection process immediately when the UE is in the RRC connection establishment initialization state, to triggering of the subsequent RRC connection establishment process immediately when there is the to-be-transmitted data, so as to quickly resume data transmission by changing the RRC connection establishment process.

In addition, it should be noted that, particularly for manner 1 and manner 2, when the user equipment has the uplink and/or downlink to-be-transmitted data or before the UE has the to-be-transmitted data, that is, before the RRC connection re-establishment process or the RRC connection establishment process is triggered for the eNB, it may be first determined whether the current serving cell of the UE meets the preset communication requirement, for example, whether signal quality, received signal strength, or the like meets a preset threshold. If the current serving cell meets the preset communication requirement, the UE may directly send the RRC connection re-establishment request or the RRC connection establishment request to the eNB, and may ignore, that is, may skip the cell selection or re-selection process. If the current serving cell does not meet the preset communication requirement, the UE may perform the cell selection or re-selection process, and may send an RRC connection re-establishment request or an RRC connection establishment request to the eNB when a cell is selected and an eNB corresponding to the cell is the eNB that sends the context information saving indication information.

In addition, for manner 1 and manner 2, it should be emphasized that, regardless of whether actual signal quality of the current UE meets the communications requirement or whether the current UE actually meets an RLF condition from a perspective of signal quality, the UE may be forcibly required to be in the RLF state.

In this embodiment, after determining that the UE has not transmitted data within the specified time, the eNB may send the context information saving indication information to the UE, and immediately after receiving the context information saving indication information, the UE may forcibly determine the UE to be in a state related to triggering of RRC connection re-establishment or triggering of RRC connection establishment, for example, the RLF state. When there is the data that needs to be transmitted, the RRC connection re-establishment process or the RRC connection establishment process may be triggered immediately based on the state related to triggering, to quickly resume data transmission by reusing the RRC connection re-establishment process or the RRC connection establishment process. In addition, because an existing RRC connection re-establishment process and an existing RRC connection establishment process in an LTE specification are reused, the UE may not need to make a complex change, and may be easy to implement.

It has been mentioned, in the foregoing embodiment, that the RRC connection re-establishment process or the RRC connection establishment process may be divided into two sub-processes: the initialization stage, namely, the cell selection or re-selection process, and the another RRC connection re-establishment process or the another RRC connection establishment process. In the following, an implementation of a cell selection or re-selection process is described with reference to an embodiment shown in FIG. 2. The cell selection or re-selection process may be applicable to all of manner 1, manner 2, manner 3, and manner 4.

FIG. 2 is a flowchart of the cell selection or re-selection process according to this embodiment of the present disclosure. As shown in FIG. 2, specific implementation of the cell selection or re-selection process may include the following steps.

Step 201. UE starts a first timer, and performs the cell selection or re-selection process within a time period corresponding to the first timer, so as to select a cell.

Step 202. The UE releases context information if no cell is selected within the time period corresponding to the first timer or the first timer expires.

It should be noted that, in this embodiment, the first timer may be configured to control a time length for saving the context information of the UE, and a length of the first timer To may be a preset value, or may be configured for the UE by an eNB. For example, when the eNB instructs the UE to save the context information, the saving indication information may be carried in a context information saving indication message, and the length of the first timer, To, may be notified to the UE in the context information saving indication message. Specifically, the length of the first timer, T0, may be a limited value, or may be a limitless value. When the first timer T0 expires, the UE may need to release the context information saved by the UE.

In addition, the UE may perform the cell selection or re-selection process under control of the first timer T0. If the UE cannot select a cell within a time period corresponding to the first timer T0, the UE may determine to release the context information, and may enter an RRC idle state.

Specifically, the performing, by the UE, the cell selection or re-selection process within a time period corresponding to the first timer, and selecting a cell, may be specifically implemented in the following manners: starting, by the UE, a second timer, and within an i^{th} time period corresponding to the second timer, suspending or stopping the second timer if a first cell is selected. The process may further include: after the second timer is suspended or stopped, if the first cell is no longer a proper cell, resetting and restarting the second timer, and selecting a second cell within an (i+1−n)^{th} time period, where the proper cell in the embodiments of the present disclosure means that the cell can make signal quality, a signal path loss, a signal transmission rate, or the like for UE data transmission that meets a service quality requirement. In this embodiment, i is an integer ranging from 1 to n, n is an integer greater than 1, and the time period corresponding to the first timer is greater than a time period corresponding to the second timer.

Specifically, within the time period corresponding to the first timer T0, the UE may execute the following cell selection or re-selection policy.

The UE may start a second timer T1. The second timer T1 may control the UE to perform an operation related to cell selection or re-selection. Then, the UE may perform cell selection or re-selection according to a cell selection or re-selection standard. For example, cell selection or re-selection may be specifically performed according to the LTE 36.304 protocol.

Within a time period corresponding to the second timer T1, if the UE selects a cell, the UE may suspend or stop the second timer T1. In addition, after a period of time, if the cell currently selected by the UE is no longer a proper cell, the UE may reset and restart the second timer T1, and then, may perform cell selection or re-selection again to select another cell. This process may be repeated until the first timer T0 expires or there is to-be-transmitted data arriving.

It should be noted that, the cell selection or re-selection process is applicable to all of manner 1, manner 2, manner 3, and manner 4, with the only difference in the time of execution and a quantity of executions for triggering the process. Specifically, for manner 1 and manner 2, because the cell selection or re-selection process and a corresponding subsequent RRC connection re-establishment process are performed successively, it may be unnecessary to perform cell selection or re-selection processes repeatedly for a plurality of second timers T1, provided that a cell is selected. However, for manner 3 and manner 4, the cell selection or re-selection process and a subsequent corresponding RRC connection re-establishment process or a subsequent corresponding RRC connection establishment process are performed separately; therefore, selection processes corresponding to a plurality of T1 timers usually need to be performed repeatedly until there is to-be-transmitted data arriving.

In addition, it should be noted that when sending context information saving indication information to the UE, the eNB may also send timer configuration information. The timer configuration information may include configuration information of the first timer T0, configuration information of the second timer T1, and configuration information of a security key timer, that is, a fourth timer T3. The fourth timer may be configured to time validity of a security key in the context information. Certainly, the timer configuration information may further include other information described in the following, for example, configuration information of a third timer T2.

In addition, generally, a base station is corresponding to a plurality of different cells. In the cell selection or re-selection process, if an eNB corresponding to the selected cell is different from the eNB that sends the context information saving indication information, or a quantity of selected-cell changes is greater than or equal to a preset quantity, when the UE has to-be-transmitted data, the UE may determine to trigger an initial RRC connection establishment process, that is, to perform new processing according to an existing RRC connection establishment process.

In addition, in a process of performing cell selection or re-selection, the UE may trigger execution of a location update process when determining that a track area of the selected cell has changed, and may establish a data radio bearer with a new base station in the location update process.

Specifically, in the cell selection or re-selection process, the UE may select a new cell, and this cell and the previous cell may not belong to a same TA (Track Area). The UE may be triggered to perform location update at this time. During conventional location update, the UE may not need to establish a data radio bearer, and only a signaling radio bearer may be established. However, in this embodiment, the UE may be required to establish a data radio bearer with the eNB during location update.

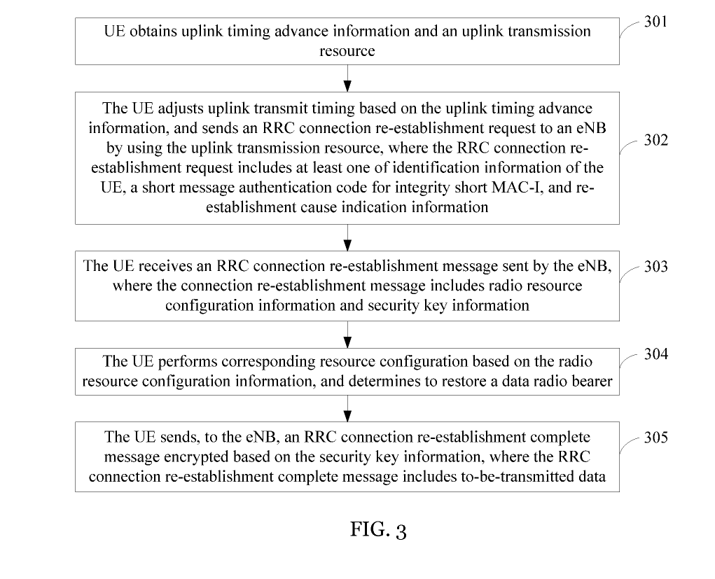

In the following, an implementation of another RRC connection re-establishment process following a cell selection or re-selection process is described with reference to an embodiment shown in FIG. 3. This process is essentially the same as for manner 1, manner 2, or manner 3, with a slight difference in the case of manner 3, and details are described later.

FIG. 3 is a flowchart of the RRC connection re-establishment process different from the cell selection or re-selection process according to this embodiment of the present disclosure. As shown in FIG. 3, the subsequent another RRC connection re-establishment process different from the cell selection or re-selection process may include the following steps.

Step 301. UE obtains uplink timing advance information and an uplink transmission resource.

During actual implementation, the UE may obtain the uplink timing advance information and/or the uplink transmission resource.

Step 302. The UE adjusts uplink transmit timing based on the uplink timing advance information, and sends an RRC connection re-establishment request to an eNB using the uplink transmission resource, where the RRC connection re-establishment request may include at least one of: identification information of the UE, a short message authentication code for integrity short MAC-I (for details, refer to 3GPP specifications), and re-establishment cause indication information.

The re-establishment cause indication information may be used to instruct the UE to resume data transmission using saved context information.

During actual implementation, the UE adjusts uplink transmit timing based on the uplink timing advance information, and/or sends the RRC connection re-establishment request to the eNB using the uplink transmission resource.

Step 303. The UE receives an RRC connection re-establishment message sent by the eNB, where the connection re-establishment message may include radio resource configuration information and security key information.

Step 304. The UE performs corresponding resource configuration based on the radio resource configuration information, and determines to restore a data radio bearer.

It should be noted that a conventional RRC connection re-establishment process may restore only a signaling radio bearer (SRB). In this embodiment, not only the SRB but also a data radio bearer (DRB) may be restored.

Step 305. The UE sends, to the eNB, an RRC connection re-establishment complete message encrypted based on the security key information, where the RRC connection re-establishment complete message may include to-be-transmitted data.

Specifically, for a manner of obtaining the uplink timing advance information and the uplink transmission resource in step 301, the UE may use the following two optional manners to obtain the uplink timing advance information and the uplink transmission resource.

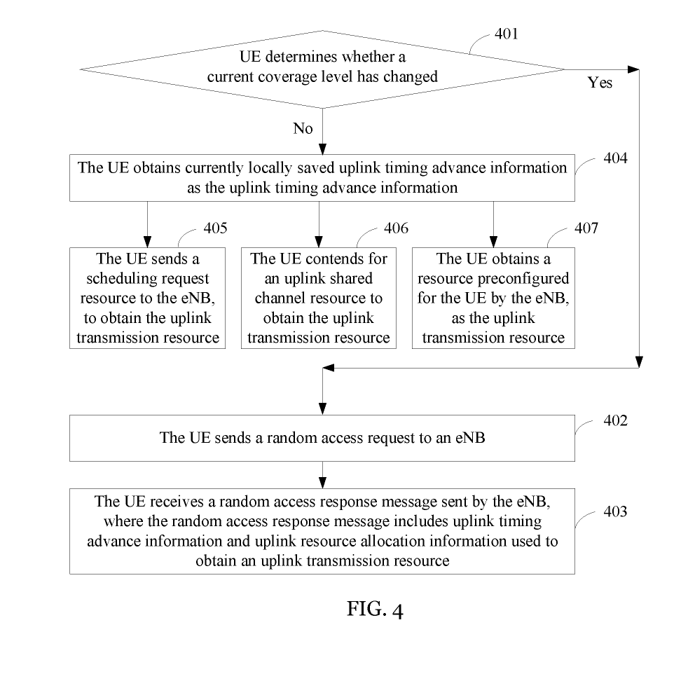

With reference to an embodiment shown in FIG. 4, a specific implementation of step 301 is described. As shown in FIG. 4, the obtaining manner may include the following steps.

Step 401. UE determines whether a current coverage level has changed; and when the coverage level has changed, performs step 402 and step 403, or when the coverage level has not changed, performs either step 404 and any one of steps 405 to 407.

Step 402. The UE sends a random access request to an eNB.

Step 403. The UE receives a random access response message sent by the eNB, where the random access response message may include uplink timing advance information and uplink resource allocation information used to obtain an uplink transmission resource.

Specifically, the UE may determine, based on radio resource management (RRM) measurement, whether the coverage level of the UE has changed. To be specific, if an RRM measurement result change amount does not exceed a preset threshold, the UE may determine that the coverage level of the UE has not changed; or if an RRM measurement result change amount exceeds a preset threshold, may determine that the coverage level of the UE has changed.

When determining that the coverage level of the UE has changed, the UE may send a random access request (preamble) to the eNB, and the eNB may feed back a random access response message to the UE. The random access response message may include uplink timing advance information and uplink resource allocation information. In this way, the UE obtains a corresponding uplink transmission resource according to the uplink resource allocation information.

Step 404. The UE obtains currently locally saved uplink timing advance information as the uplink timing advance information.

If the UE determines that the coverage level has not changed, the UE may use the currently saved uplink timing advance information, so as to adjust uplink transmit timing when an RRC connection re-establishment request message may need to be sent.

The uplink transmission resource may be obtained in a manner described in any one of the following three steps.

Step 405. The UE sends a scheduling request resource to the eNB, to obtain the uplink transmission resource.

To obtain the uplink transmission resource, the UE may first use a saved scheduling request (SR) resource configuration to send an SR resource to the eNB, so as to obtain the uplink transmission resource. Then, the UE may send an RRC connection re-establishment request based on the obtained uplink transmission resource.

Step 406. The UE contends for an uplink shared channel resource to obtain the uplink transmission resource.

The UE may contend for the uplink shared channel resource to send the RRC connection re-establishment request to the eNB.

Step 407. The UE obtains a resource preconfigured for the UE by the eNB, as the uplink transmission resource.

The UE may send the RRC connection re-establishment request using the resource preconfigured by the eNB. Specifically, the preconfigured resource may be notified to the UE by the eNB when the UE is instructed to save the context information.

After the UE obtains the uplink timing advance information and the uplink transmission resource based on the obtaining manners in the foregoing two different cases, the UE may adjust uplink transmit timing based on the uplink timing advance information, and may send the RRC connection re-establishment request to the eNB using the uplink transmission resource.

Specifically, a manner of sending the RRC connection re-establishment request may be as follows:

The RRC connection re-establishment request may carry identification information of the UE, for example, a cell radio network temporary identifier (C-RNTI) or an s-temporary mobile subscriber identity (S-TMSI). A message authentication code for integrity (MAC-I) may be calculated, and least important 16 bits of the MAC-I may be intercepted to obtain a short MAC-I, and the short MAC-I may be carried in the RRC connection re-establishment request, for the eNB to determine the UE. The short MAC-I may be generated based on input parameters which may be the identification information of the UE, a cell identifier of a current cell of the UE, and a physical layer cell identifier of a cell that provides a service for the UE before re-establishment (the cell that provides a service for the UE before re-establishment may be the same as the current cell of the UE).

It should be noted that the short MAC-I may be generated using the C-RNTI or the S-TMSI. In addition, when the C-RNTI is used, a C-RNTI that is allocated by a previous serving base station and that is saved currently by the UE may be used.

When the short MAC-I is generated using the C-RNTI, but the RRC connection re-establishment request may include the S-TMSI, the eNB needs to derive, based on the S-TMSI reported by the UE, the C-RNTI corresponding to the UE, and then may verify, using the derived C-RNTI, the short MAC-I generated by the eNB and the short MAC-I reported by the UE. To do this, the eNB may need to save the S-TMSI of the UE after instructing the UE to save the context information.

In addition, the RRC connection re-establishment request may further carry indication information used to indicate connection resumption or data transmission resumption, namely, the re-establishment cause indication information, to notify an RRC connection re-establishment cause to the eNB.

After receiving the RRC connection re-establishment request sent by the UE, the eNB may allocate radio resource configuration information and security key information (for example, nextHopChainingCount) for the UE, and may send an RRC connection re-establishment message with the allocated information to the UE.

The UE may receive the RRC connection re-establishment message sent by the eNB, may perform corresponding resource configuration based on the radio resource configuration information, may restore a DRB, and may send, to the eNB, an RRC connection re-establishment complete message encrypted based on the security key information.

Specifically, the UE may update an intermediate key KeNB based on the security key information in the RRC connection re-establishment message, may generate a message integrity protection key K_{RRCinc} based on a new intermediate key KeNB and an integrity protection algorithm, may generate a message encryption key K_{RRCenc} and a data encryption key K_{UPenc} based on the updated intermediate key KeNB and an encryption algorithm, and may activate the foregoing keys immediately for later use.

The UE may send an RRC connection re-establishment complete message to the eNB. Specifically, the UE may need to encrypt and apply integrity protection on the RRC connection re-establishment complete message based on the newly generated encryption and integrity protection keys, for example, the message integrity protection key K_{RRCinc} and the message encryption key K_{RRCenc}. The RRC connection re-establishment complete message may further include to-be-transmitted data, to implement uplink transmission of the to-be-transmitted data.

Regarding the embodiments shown in FIG. 2 and FIG. 3, execution by the UE in manner 1, manner 2, and manner 3 may be as follows: for manner 1 and manner 2, when the UE determines that there is to-be-transmitted data, embodiments shown in FIG. 2 and FIG. 3 may be executed in sequence; and for manner 3, the embodiment shown in FIG. 2 may be executed first, and when the UE determines that there is to-be-transmitted data, the embodiment shown in FIG. 3 may be executed.

It should be noted that, for manner 3, when it is determined that the UE is in an RRC connection re-establishment initialization state, a cell selection or re-selection process may be performed. During this time, when the UE has to-be-transmitted data, the UE may immediately start a third timer T2 and may stop a second timer T1 and a first timer T0, so as to control a subsequent RRC connection re-establishment process using T2.

Specifically, if the UE receives, within a time period corresponding to the third timer T2, the RRC connection re-establishment message sent by the eNB, timing of the third timer T2 may be stopped. This indicates that RRC connection re-establishment succeeds. If the UE does not receive the RRC connection re-establishment message within a time period corresponding to the third timer T2, it may indicate that RRC connection re-establishment failed. In this case, the UE may perform one or more of the following operations: entering an RRC idle state; stopping the first timer; triggering sending of an RRC connection establishment request to the base station corresponding to the cell; and triggering cell selection or re-selection, and sending an RRC connection establishment request to the base station corresponding to the selected cell.

In the embodiments shown in FIG. 2 and FIG. 3, after the UE forcibly determines the UE to be in a state related to triggering of RRC connection re-establishment, when there is data that needs to be transmitted, the UE may perform an RRC connection re-establishment process corresponding to the specific trigger related state, so as to quickly and conveniently resume data transmission and complete transmission of to-be-transmitted data.

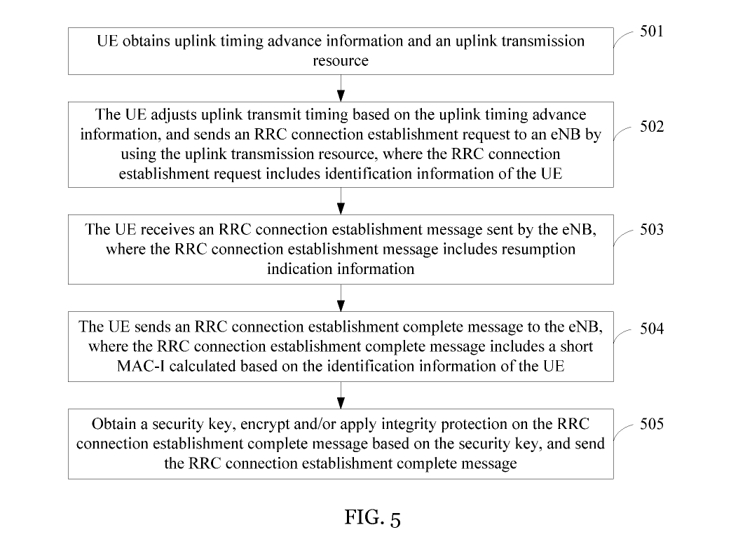

In the following, an implementation of another RRC connection establishment process following a cell selection or re-selection process is described with reference to an embodiment shown in FIG. 5. The process is described with respect to manner 4.

FIG. 5 is a flowchart of an implementation of an RRC connection establishment process different from the cell selection or re-selection process according to this embodiment of the present disclosure. As shown in FIG. 5, the subsequent another RRC connection establishment process different from the cell selection or re-selection process may include the following steps.

Step 501. UE obtains uplink timing advance information and an uplink transmission resource.

Step 502. The UE adjusts uplink transmit timing based on the uplink timing advance information, and sends an RRC connection establishment request to an eNB using the uplink transmission resource, where the RRC connection establishment request may include identification information of the UE.

The identification information of the user equipment may include an s-temporary mobile subscriber identity (S-TMSI).

In this embodiment, the uplink timing advance information and the uplink transmission resource may be obtained with reference to the manner in the embodiment shown in FIG. 4.

Step 503. The UE receives an RRC connection establishment message sent by the eNB, where the RRC connection establishment message may include resumption indication information.

The resumption indication information may be used to instruct the UE to resume data transmission using saved context information. The RRC connection establishment message may be sent when the eNB determines, based on the S-TMSI, that the context information of the UE is valid.

Specifically, after receiving the RRC connection establishment request sent by the UE, the eNB determines, based on the S-TMSI of the UE, whether the context information of the UE is valid. When determining that the context information of the UE is valid for the eNB, the eNB may send the RRC connection establishment message to the UE. The RRC connection establishment message may carry indication information used to instruct the UE to resume data transmission using the saved context information, namely, the resumption indication information.

It should be noted that if an MME changed the S-TMSI of the UE before the UE enters a state of context saving, the MME may need to notify a new S-TMSI of the UE to the eNB. Then, when the UE sends the RRC connection establishment request to the eNB during access to the eNB in a resumption process, the new S-TMSI allocated by the MME may be provided. Because the MME also notifies the current new S-TMSI of the UE to the eNB, the eNB can find context information of the UE, and determine that the context information of the UE is valid. Otherwise, if the UE provides a new S-TMSI, but the eNB does not locally know the new S-TMSI of the UE, the eNB may misunderstand that the context information of the UE is not saved.

Step 504. The UE may send an RRC connection establishment complete message to the eNB, where the RRC connection establishment complete message may include a short MAC-I calculated based on the identification information of the UE.

After receiving the RRC connection establishment message sent by the eNB, the UE may determine that the RRC connection establishment message includes indication information used to instruct to resume transmission using saved context, and the UE may determine to send the RRC connection establishment complete message to the eNB. First, the UE may calculate a message authentication code for integrity MAC-I using identification information, for example, a C-RNTI or an S-TMSI, of the UE, and intercepts least important 16 bits of the MAC-I to obtain a short MAC-I. Further, the RRC connection establishment complete message may carry the short MAC-I.

The MAC-I may be generated based on input parameters which may be the identification information of the UE, a cell identifier of a current cell of the UE, and a physical layer cell identifier of a cell that provides a service for the UE before a current connection is established (the cell that provides the service for the UE before the current connection is established may be the same as the current cell of the UE).

It should be noted that when the short MAC-I may be calculated using the C-RNTI, an original C-RNTI saved in the context information by the UE may be used, or a C-RNTI that is newly allocated by the eNB and that may be obtained before the RRC connection establishment message is received may be used for calculation. The new C-RNTI may be carried in a context saving indication message and allocated to the UE.

It should be noted that the eNB always adds configuration information of an SRB (which may include an SRB 1 and an SRB 2) to the RRC connection establishment message, so that when a saved SRB configuration is lost locally on a UE side, the UE can still continue to complete the RRC connection establishment process successfully based on an SRB configuration provided in the RRC connection establishment message. Even if local context information of the UE is lost, the UE may not need to send another RRC connection establishment request, but can complete RRC connection establishment using a current RRC connection establishment message based on a conventional RRC connection establishment process. For the eNB, if the eNB finds that the RRC connection establishment complete message sent by the UE is the same as the conventional RRC connection establishment complete message, for example, if no security protection is applied on the message or no short MAC-I is carried in the message, the eNB may send a security activation command to the UE by following a conventional procedure.

Step 505. Obtain a security key, encrypt and/or apply integrity protection on the RRC connection establishment complete message based on the security key, and send the RRC connection establishment complete message.

Optionally, the to-be-transmitted data may alternatively be sent after being encrypted based on the security key.

In this embodiment, the RRC connection establishment complete message and the to-be-transmitted data may be sent with encryption. A specific encryption key obtaining manner and an encrypted sending manner may be implemented in the following manners:

Optionally, the UE directly obtains a previous security key pre-saved by the UE. The security key may include a message integrity protection key K_{RRCinc}, a message encryption key K_{RRCenc}, and a data encryption key K_{UPenc}.

In this case, the UE may encrypt and/and apply integrity protection on the RRC connection establishment complete message based on the message integrity protection key K_{RRCinc} and the message encryption key K_{RRCenc}, and send the RRC connection establishment complete message. The UE may encrypt and send the to-be-transmitted data based on the data encryption key K_{UPenc}.

Optionally, after the UE sends the RRC connection establishment complete message to the eNB, the eNB may further send security key indication information to the UE. The security key indication information may include security key information. The UE may update an intermediate key KeNB based on the security key information after receiving the security key indication information sent by the eNB, may generate a message integrity protection key K_{RRCinc} based on an updated intermediate key KeNB and an integrity protection algorithm, and may generate a message encryption key K_{RRCenc} and a data encryption key K_{UPenc} based on the updated intermediate key KeNB and an encryption algorithm.

The security key indication information may be carried in any one of the following messages: a key update indication message, a data transmission indication message, an RRC connection establishment message, and a message carrying the UE context saving indication information.

In this case, the UE may encrypt and send a subsequent RRC control message based on the message integrity protection key K_{RRCinc} and the message encryption key K_{RRCenc}. The UE may further encrypt and send the to-be-transmitted data based on the data encryption key K_{UPenc}.

It should be noted that the RRC connection establishment request may be sent after encryption and/or integrity protection are/is performed based on the security key. This is similar to processing on the RRC connection establishment complete message, and details are not repeated.

Optionally, the UE may send the RRC connection establishment complete message to the eNB in the following several optional implementations:

Manner 1: The RRC connection establishment complete message may include a short MAC-I calculated based on the identification information of the UE.

Manner 2: The UE sends, to the eNB, an RRC connection establishment complete message encrypted using the message integrity protection key K_{RRCinc} and the message encryption key K_{RRCenc}. The RRC connection establishment complete message may include a short MAC-I calculated based on the identification information of the UE.

Manner 3: The UE sends, to the eNB, an RRC connection establishment complete message encrypted using the message integrity protection key K_{RRCinc} and the message encryption key K_{RRCenc}. The RRC connection establishment complete message may not carry a short MAC-I.

Regarding manner 1, manner 2, manner 3, and manner 4, the following separately describes, from a perspective of interaction between UE and an eNB, resumption of data transmission through an RRC connection re-establishment process.

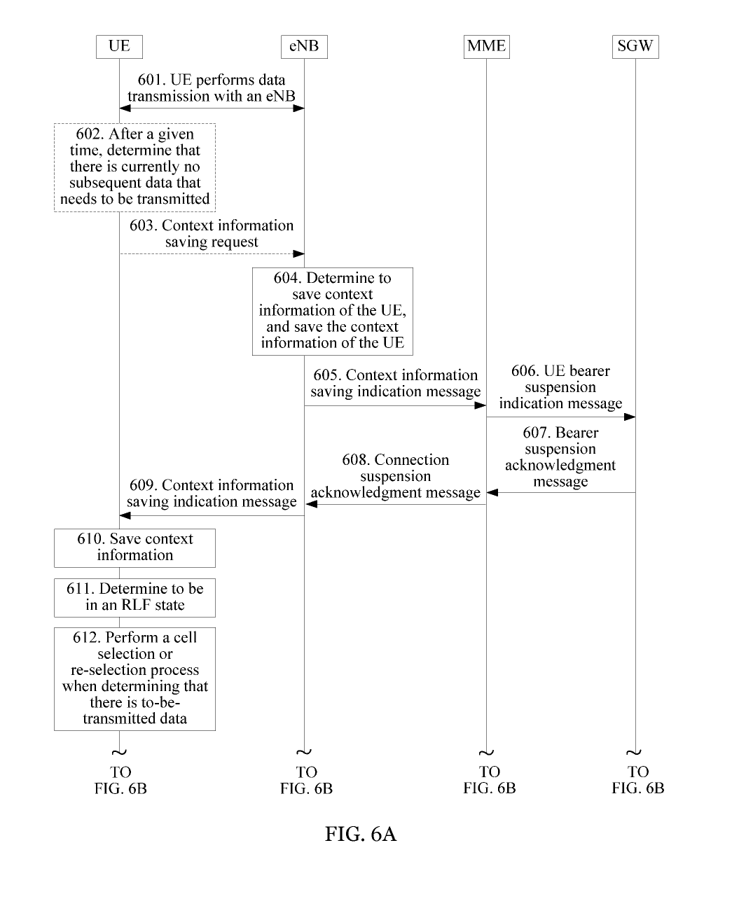

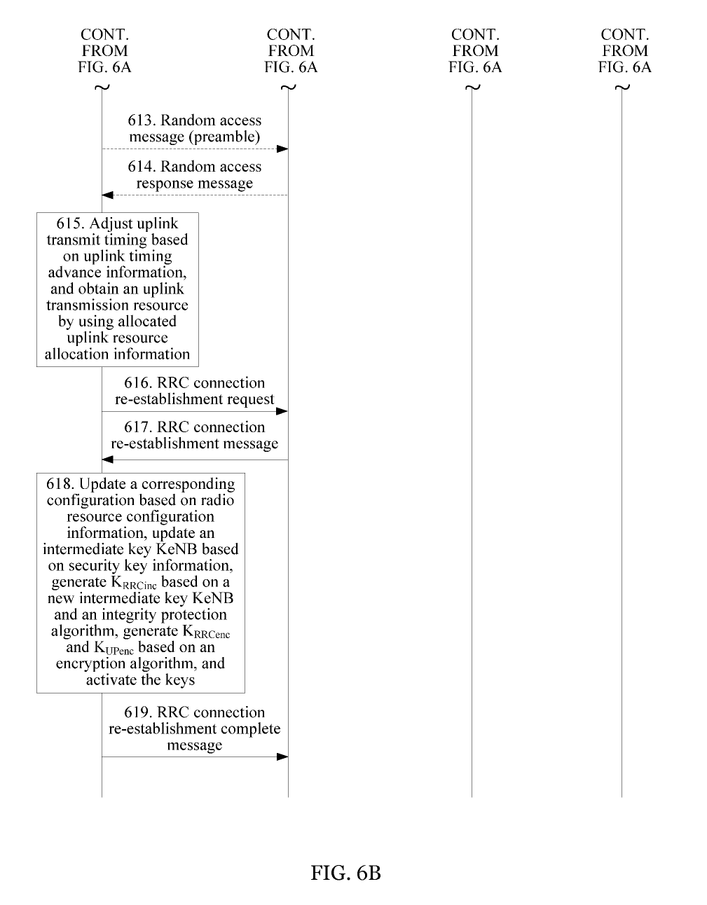

FIG. 6A and FIG. 6B are a diagram of signaling interaction of Embodiment 2 of a data transmission processing method according to an embodiment of the present disclosure. This embodiment is described with respect to manner 1. As shown in FIG. 6A and FIG. 6B, the method specifically may include the following steps.

Step 601. UE performs data transmission with an eNB.

Step 602. After a given time, the UE determines that there is currently no subsequent data that needs to be transmitted.

Step 603. The UE sends a context information saving request to the eNB.

Alternatively, the context information saving request may be referred to as an RRC suspension request used to request to save context information of the UE.

Step 602 and step 603 are optional steps, and therefore, are marked by dashed lines in the figure.

Step 604. The eNB determines to save context information of the UE, and saves the context information of the UE.

Alternatively, the context information saving request is equivalently referred to as RRC connection suspension. Specifically, when receiving the context information saving request sent by the UE, the eNB may determine that the context information of the UE may be saved. Alternatively, when determining, depending on a status of data transmission with the UE, that the UE has not transmitted data within a specified time, the eNB may automatically determine that saving the context information of the UE (or referred to as RRC connection suspension) may be performed.

Step 605. The eNB sends a UE context information saving indication message to an MME.

Alternatively, the context information saving indication message is referred to as a context information saving request message, an RRC connection suspension request message, or an RRC connection suspension indication message, used to notify the MME that the UE is to be in a context information saved state or an RRC connection suspended state.

Step 606. The MME sends a UE bearer suspension indication message to an SGW.

The indication message may be used to indicate to the SGW that a bearer of the UE is to be in a suspended state or a data transmission suspended state.

After receiving the UE context information saving indication message sent by the eNB, the MME may determine that the UE is to be in a context information saved state or an RRC connection suspended state. Then, the MME may send an indication message to the SGW, to indicate to the SGW that a bearer of the UE is to be in a suspended state or a data transmission suspended state.

Step 607. The SGW sends a bearer suspension acknowledgment message to the MME.

Step 608. The MME sends a connection suspension acknowledgment message to the eNB.

Step 609. The eNB sends a context information saving indication message to the UE.

Alternatively, the context information saving indication message is equivalently referred to as an RRC connection suspension indication message or an RRC connection release indication message. The context information saving indication message may carry context information saving indication information, to order the UE to save the context information of the UE.

Step 610. The UE saves context information.

Step 611. The UE determines to be in an RLF state.

Step 612. The UE performs a cell selection or re-selection process when determining that there is to-be-transmitted data.

Specifically, when determining that the context information of the UE needs to be saved or determining that the UE needs to be in an RRC-suspended state, the UE may determine to be currently in an RLF state (or referred to as an extended RLF state or a virtual RLF state), and the UE may not immediately trigger an RRC connection re-establishment process, but may trigger an RRC connection re-establishment process when at least one of the following trigger conditions is met: uplink data of the UE arrives or the UE has uplink data that needs to be sent; the UE receives a data transmission notification message, for example, a paging message, sent by the eNB; and when determining that there is new uplink and/or downlink data that need/needs to be transmitted, the UE triggers a process of re-establishing an RRC connection to the eNB, and performs a cell selection or re-selection process, where for execution of the cell selection or re-selection process, refer to the foregoing related embodiment.

Step 613. The UE sends a random access message (preamble) to the eNB.

Step 614. The eNB sends a random access response message to the UE.

The random access response message may include uplink timing advance information and uplink resource allocation information.

Step 615. The UE adjusts uplink transmit timing based on uplink timing advance information, and obtains an uplink transmission resource using uplink resource allocation information.

Step 616. The UE sends an RRC connection re-establishment request to the eNB.

The RRC connection re-establishment request may include identification information, for example, a C-RNTI, of the UE, a short message authentication code for integrity short MAC-I, and re-establishment cause indication information. The indication information may be used to indicate an RRC connection re-establishment cause.

Step 617. The eNB sends an RRC connection re-establishment message to the UE.

The connection re-establishment message may include radio resource configuration information and security key information, for example, nextHopChainingCount.

Step 618. The UE updates a corresponding configuration based on radio resource configuration information, updates an intermediate key KeNB based on security key information, generates K_{RRCinc} based on a new intermediate key KeNB and an integrity protection algorithm, generates K_{RRCenc} and K_{UPenc} based on an encryption algorithm, and activates the keys.

Step 619. The UE sends an RRC connection re-establishment complete message to the eNB.

Specifically, the UE may need to encrypt and apply integrity protection on the RRC connection re-establishment complete message based on newly generated encryption and integrity protection keys. The RRC connection re-establishment complete message may further include to-be-transmitted data.

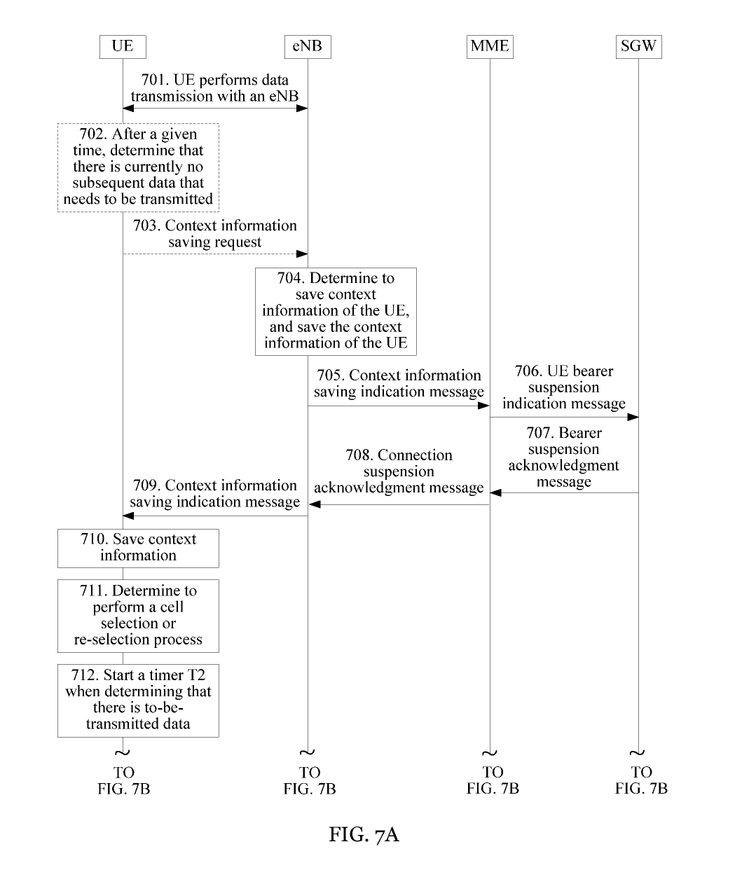

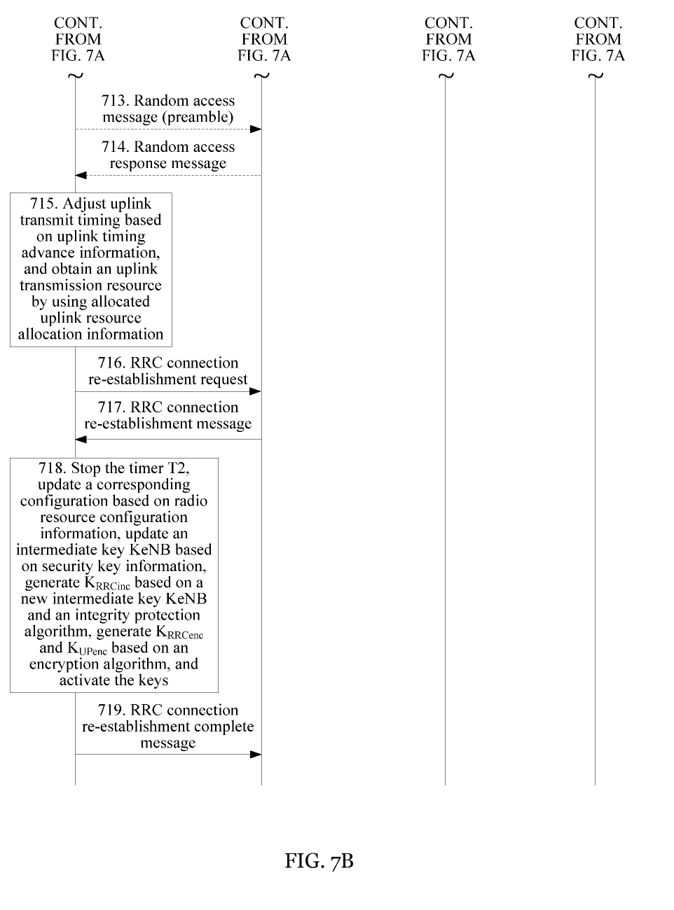

FIG. 7A and FIG. 7B are a diagram of signaling interaction of Embodiment 3 of a data transmission processing method according to an embodiment of the present disclosure. This embodiment is described with respect to manner 3. As shown in FIG. 7A and FIG. 7B, the method may include the following steps.

Step 701. UE performs data transmission with an eNB.

Step 702. After a given time, the UE determines that there is currently no subsequent data that needs to be transmitted.

Step 703. The UE sends a context information saving request to the eNB.

Alternatively, the context information saving request may be referred to as an RRC suspension request used to request to save context information of the UE.

Step 702 and step 703 are optional steps, and therefore, are marked by dashed lines in the figure.

Step 704. The eNB determines to save context information of the UE, and saves the context information of the UE.

Alternatively, the context information saving request is equivalently referred to as RRC connection suspension. Specifically, when receiving the context information saving request sent by the UE, the eNB may determine that the context information of the UE may be saved. Alternatively, when determining, depending on a status of data transmission with the UE, that the UE has not transmitted data within a specified time, the eNB may automatically determine that saving the context information of the UE (or referred to as RRC connection suspension) may be performed.

Step 705. The eNB sends a UE context information saving indication message to an MME.

Alternatively, the context information saving indication message is referred to as a context information saving request message, an RRC connection suspension request message, or an RRC connection suspension indication message, used to notify the MME that the UE is to be in a context information saved state or an RRC connection suspended state.

Step 706. The MME sends a UE bearer suspension indication message to an SGW.

The indication message may be used to indicate to the SGW that a bearer of the UE is to be in a suspended state or a data transmission suspended state.

After receiving the UE context information saving indication message sent by the eNB, the MME may determine that the UE is to be in a context information saved state or an RRC connection suspended state. Then, the MME may send an indication message to the SGW, to indicate to the SGW that a bearer of the UE is to be in a suspended state or a data transmission suspended state.

Step 707. The SGW sends a bearer suspension acknowledgment message to the MME.

Step 708. The MME sends a connection suspension acknowledgment message to the eNB.

Step 709. The eNB sends a context information saving indication message to the UE.

Alternatively, the context information saving indication message is equivalently referred to as an RRC connection suspension indication message or an RRC connection release indication message. The context information saving indication message may carry context information saving indication information, to order the UE to save the context information of the UE.

Step 710. The UE saves context information.

Step 711. The UE determines to perform a cell selection or re-selection process.

Alternatively, the UE first determines to enter an RLF state, and then determines to trigger the cell selection or re-selection process.

For execution of the cell selection or re-selection process, refer to the foregoing related embodiment.

Step 712. The UE starts a timer T2 when determining that there is to-be-transmitted data.

Specifically, after the UE performs cell selection or re-selection, that is, after a cell is selected, the UE may not immediately trigger a subsequent RRC connection re-establishment process, but may trigger a subsequent RRC connection re-establishment process when at least one of the following trigger conditions is met: uplink data of the UE arrives or the UE has uplink data that needs to be sent; the UE receives a data transmission notification message, for example, a paging message, sent by the eNB; and when determining that there is new uplink and/or downlink data that need/needs to be transmitted, the UE triggers a process of re-establishing a subsequent RRC connection to the eNB.

Step 713. The UE sends a random access message (preamble) to the eNB.

Step 714. The eNB sends a random access response message to the UE.

The random access response message may include uplink timing advance information and uplink resource allocation information.

Step 715. The UE adjusts uplink transmit timing based on uplink timing advance information, and obtains an uplink transmission resource using allocated uplink resource allocation information.

Step 716. The UE sends an RRC connection re-establishment request to the eNB.

The RRC connection re-establishment request may include identification information, for example, a C-RNTI, of the UE, a short message authentication code for integrity short MAC-I, and re-establishment cause indication information. The indication information may be used to indicate an RRC connection re-establishment cause.

Step 717. The eNB sends an RRC connection re-establishment message to the UE.

The connection re-establishment message may include radio resource configuration information and security key information, for example, nextHopChainingCount.

Step 718. The UE stops the timer T2, updates a corresponding configuration based on radio resource configuration information, updates an intermediate key KeNB based on security key information, generates K_{RRCinc} based on a new intermediate key KeNB and an integrity protection algorithm, generates K_{RRCenc} and K_{UPenc} based on an encryption algorithm, and activates the keys.

If the UE receives the RRC connection re-establishment message, it may indicate that RRC connection re-establishment succeeds, and the timer T2 is stopped; or if the UE does not receive the RRC connection re-establishment message, it may indicate that RRC connection re-establishment fails, and the UE enters an RRC idle state.

Step 719. The UE sends an RRC connection re-establishment complete message to the eNB.

Specifically, the UE may need to encrypt and apply integrity protection on the RRC connection re-establishment complete message based on newly generated encryption and integrity protection keys. The RRC connection re-establishment complete message may further include to-be-transmitted data.

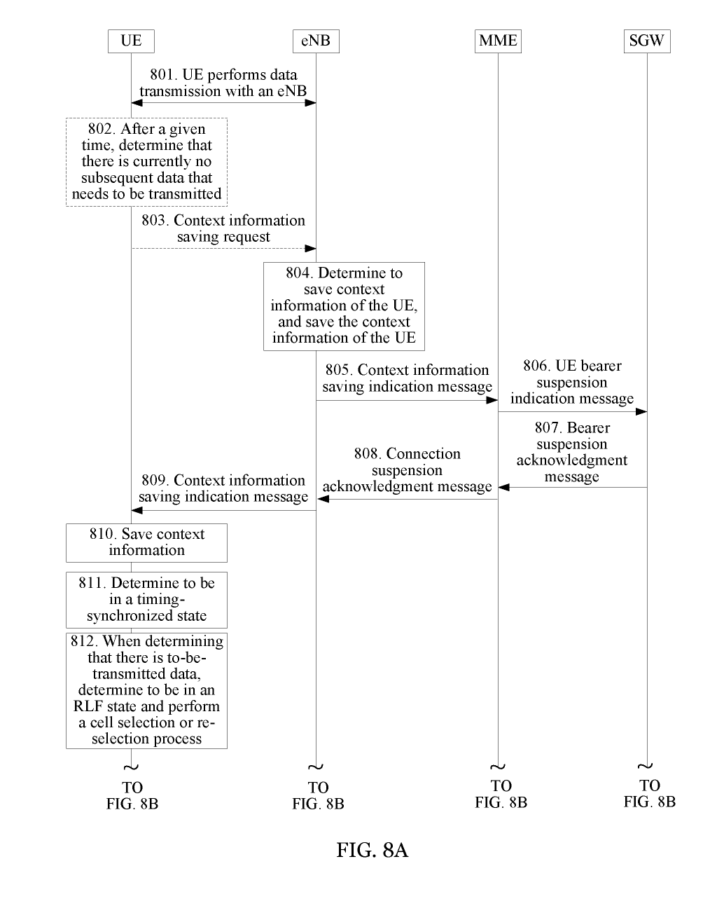

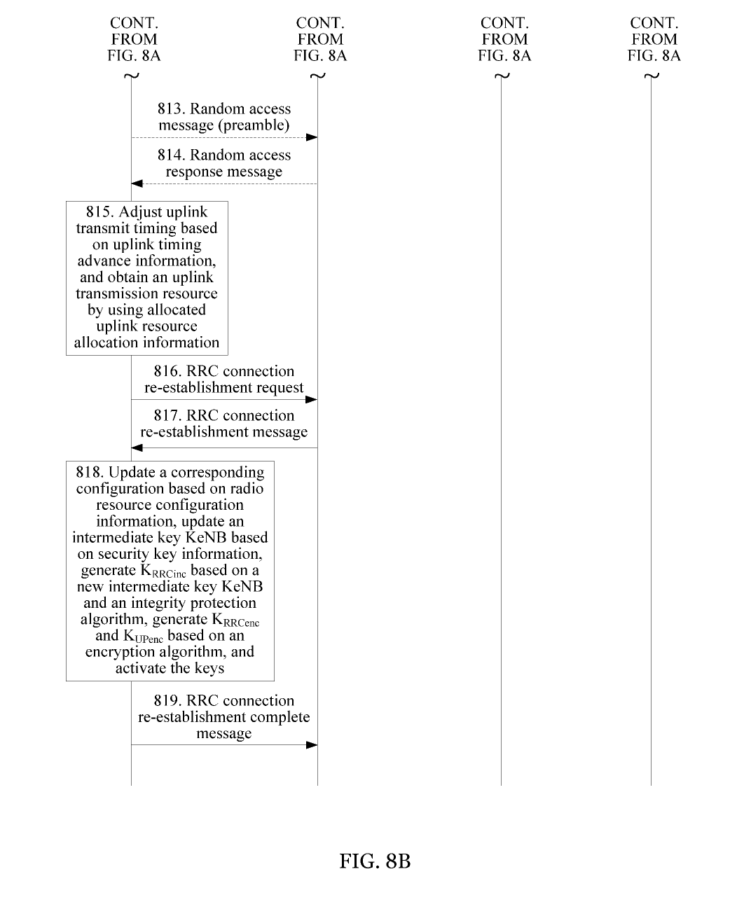

FIG. 8A and FIG. 8B are a diagram of signaling interaction of Embodiment 4 of a data transmission processing method according to an embodiment of the present disclosure. This embodiment is described with respect to manner 2. As shown in FIG. 8A and FIG. 8B, the method may include the following steps.

Step 801. UE performs data transmission with an eNB.

Step 802. After a given time, the UE determines that there is currently no subsequent data that needs to be transmitted.

Step 803. The UE sends a context information saving request to the eNB.

Alternatively, the context information saving request may be referred to as an RRC suspension request used to request to save context information of the UE.

Step 802 and step 803 are optional steps, and therefore, are marked by dashed lines in the figure.

Step 804. The eNB determines to save context information of the UE, and saves the context information of the UE.

Alternatively, the context information saving request is equivalently referred to as RRC connection suspension. Specifically, when receiving the context information saving request sent by the UE, the eNB may determine that the context information of the UE may be saved. Alternatively, when determining, depending on a status of data transmission with the UE, that the UE has not transmitted data within a specified time, the eNB may automatically determine that saving the context information of the UE (or referred to as RRC connection suspension) may be performed.

Step 805. The eNB sends a UE context information saving indication message to an MME.

Alternatively, the context information saving indication message is referred to as a context information saving request message, an RRC connection suspension request message, or an RRC connection suspension indication message, used to notify the MME that the UE is to be in a context information saved state or an RRC connection suspended state.

Step 806. The MME sends a UE bearer suspension indication message to an SGW.

The indication message may be used to indicate to the SGW that a bearer of the UE is to be in a suspended state or a data transmission suspended state.

After receiving the UE context information saving indication message sent by the eNB, the MME may determine that the UE is to be in a context information saved state or an RRC connection suspended state. Then, the MME may send an indication message to the SGW, to indicate to the SGW that a bearer of the UE is to be in a suspended state or a data transmission suspended state.

Step 807. The SGW sends a bearer suspension acknowledgment message to the MME.

Step 808. The MME sends a connection suspension acknowledgment message to the eNB.

Step 809. The eNB sends a context information saving indication message to the UE.

Alternatively, the context information saving indication message is equivalently referred to as an RRC connection suspension indication message or an RRC connection release indication message. The context information saving indication message may carry context information saving indication information, to order the UE to save the context information of the UE.

Step 810. The UE saves the context information.

Step 811. The UE determines to be in a timing-synchronized state.

Specifically, the UE may start a timer T3-1, and the UE may always be determined to be in the timing-synchronized state within a time length of the timer.

Step 812. When determining that there is to-be-transmitted data, the UE determines to be in an RLF state and performs a cell selection or re-selection process.

Specifically, the UE may trigger an RLF event when at least one of the following trigger conditions is met: uplink data of the UE arrives or the UE has uplink data that needs to be sent; the UE receives a data transmission notification message, for example, a paging message, sent by the eNB; and the UE triggers an RLF event when determining that there is new uplink and/or downlink data that need/needs to be transmitted, to perform a process of re-establishing an RRC connection to the eNB and perform the cell selection or re-selection process, where for execution of the cell selection or re-selection process, refer to the foregoing related embodiment.

Step 813. The UE sends a random access message (preamble) to the eNB.

Step 814. The eNB sends a random access response message to the UE.

The random access response message may include uplink timing advance information and uplink resource allocation information.

Step 815. The UE adjusts uplink transmit timing based on uplink timing advance information, and obtains an uplink transmission resource using allocated uplink resource allocation information.

Step 816. The UE sends an RRC connection re-establishment request to the eNB.

The RRC connection re-establishment request may include identification information, for example, a C-RNTI, of the UE, a short message authentication code for integrity short MAC-I, and re-establishment cause indication information. The indication information may be used to indicate an RRC connection re-establishment cause.

Step 817. The eNB sends an RRC connection re-establishment message to the UE.

The connection re-establishment message may include radio resource configuration information and security key information, for example, nextHopChainingCount.

Step 818. The UE updates a corresponding configuration based on radio resource configuration information, updates an intermediate key KeNB based on security key information, generates K_{RRCinc} based on a new intermediate key KeNB and an integrity protection algorithm, generates K_{RRCenc} and K_{UPenc} based on an encryption algorithm, and activates the keys.

Step 819. The UE sends an RRC connection re-establishment complete message to the eNB.

Specifically, the UE may need to encrypt and apply integrity protection on the RRC connection re-establishment complete message based on newly generated encryption and integrity protection keys. The RRC connection re-establishment complete message may further include to-be-transmitted data.

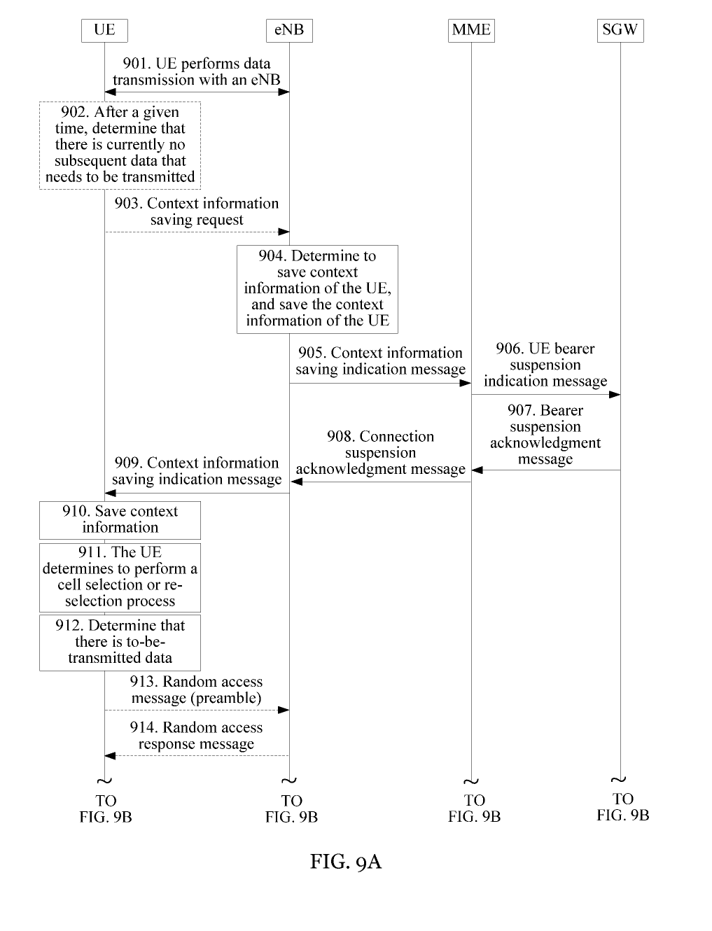

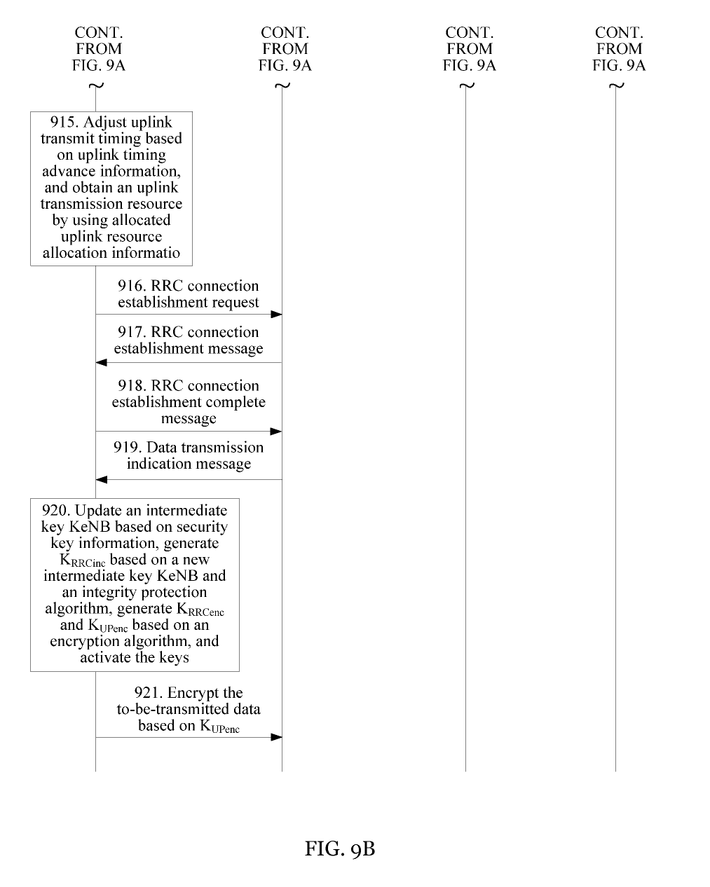

FIG. 9A and FIG. 9B are a diagram of signaling interaction of Embodiment 4 of a data transmission processing method according to an embodiment of the present disclosure. This embodiment is described with respect to manner 4. As shown in FIG. 9A and FIG. 9B, the method may include the following steps.

Step 901. UE performs data transmission with an eNB.

Step 902. After a given time, the UE determines that there is currently no subsequent data that needs to be transmitted.

Step 903. The UE sends a context information saving request to the eNB.

Alternatively, the context information saving request may be referred to as an RRC suspension request used to request to save context information of the UE.

Step 902 and step 903 are optional steps, and therefore, are marked by dashed lines in the figure.

Step 904. The eNB determines to save context information of the UE, and saves the context information of the UE.

Alternatively, the context information saving request is equivalently referred to as RRC connection suspension. Specifically, when receiving the context information saving request sent by the UE, the eNB may determine that the context information of the UE may be saved. Alternatively, when determining, depending on a status of data transmission with the UE, that the UE has not transmitted data within a specified time, the eNB may automatically determine that saving the context information of the UE (or referred to as RRC connection suspension) may be performed.

Step 905. The eNB sends a UE context information saving indication message to an MME.

Alternatively, the context information saving indication message is referred to as a context information saving request message, an RRC connection suspension request message, or an RRC connection suspension indication message, used to notify the MME that the UE is to be in a context information saved state or an RRC connection suspended state.

Step 906. The MME sends a UE bearer suspension indication message to an SGW.

The indication message may be used to indicate to the SGW that a bearer of the UE is to be in a suspended state or a data transmission suspended state.

After receiving the UE context information saving indication message sent by the eNB, the MME may determine that the UE is to be in a context information saved state or an RRC connection suspended state. Then, the MME may send an indication message to the SGW, to indicate to the SGW that a bearer of the UE is to be in a suspended state or a data transmission suspended state.

Step 907. The SGW sends a bearer suspension acknowledgment message to the MME.

Step 908. The MME sends a connection suspension acknowledgment message to the eNB.

Step 909. The eNB sends a context information saving indication message to the UE.

Alternatively, the context information saving indication message is equivalently referred to as an RRC connection suspension indication message or an RRC connection release indication message. The context information saving indication message may carry context information saving indication information, to order the UE to save the context information of the UE.

Step 910. The UE saves the context information.

Step 911. The UE determines to perform a cell selection or re-selection process.

For execution of the cell selection or re-selection process, refer to the foregoing related embodiment.

Step 912. The UE determines that there is to-be-transmitted data.

Specifically, after the UE completes cell selection or re-selection, that is, after cell selection or re-selection is performed and a cell is selected, the UE may not immediately trigger a subsequent RRC connection establishment process, but may trigger a subsequent RRC connection establishment process when at least one of the following trigger conditions is met: uplink data of the UE arrives or the UE has uplink data that needs to be sent; the UE receives a data transmission notification message, for example, a paging message, sent by the eNB; and when determining that there is new uplink and/or downlink data that need/needs to be transmitted, the UE triggers a process of establishing a subsequent RRC connection to the eNB.

Step 913. The UE sends a random access message (preamble) to the eNB.

Step 914. The eNB sends a random access response message to the UE.

The random access response message may include uplink timing advance information and uplink resource allocation information.

Step 915. The UE adjusts uplink transmit timing based on uplink timing advance information, and obtains an uplink transmission resource using allocated uplink resource allocation information.

Step 916. The UE sends an RRC connection establishment request to the eNB.

The RRC connection establishment request message may carry identification information, an S-TMSI, of the UE.

Step 917. The eNB sends an RRC connection establishment message to the UE.

After receiving the RRC connection establishment request sent by the UE, the eNB may determine, based on the S-TMSI of the UE, whether the context information of the UE is valid. When determining that the context information of the UE is valid for the eNB, the eNB may send the RRC connection establishment message to the UE. The RRC connection establishment message may carry resumption indication information used to instruct the UE to resume data transmission using the saved context information.

Step 918. The UE determines to send an RRC connection establishment complete message to the eNB.

The RRC connection establishment complete message may carry a short MAC-I. The short MAC-I may be obtained by intercepting least significant 16 bits of the MAC-I after the MAC-I is calculated by the UE using identification information, for example, a C-RNTI or an S-TMSI, of the UE.

Step 919. The eNB sends a data transmission indication message to the UE.

The data transmission indication message may include security key information, for example, nextHopChainingCount.

Step 920. The UE updates an intermediate key KeNB based on security key information, generates K_{RRCinc} based on a new intermediate key KeNB and an integrity protection algorithm, generates K_{RRCenc} and K_{UPenc} based on an encryption algorithm, and activates the keys.

Step 921. The UE encrypts the to-be-transmitted data based on K_{UPenc} and transmits the encrypted to-be-transmitted data to the eNB.

The UE may further encrypt and apply integrity protection on a subsequent RRC control message using the newly generated encryption and integrity protection keys K_{RRCinc} and K_{RRCenc}, and may send the subsequent RRC control message.

In the foregoing embodiments shown in FIG. 6A, FIG. 6B, FIG. 7A, FIG. 7B, FIG. 8A, FIG. 8B, FIG. 9A, and FIG. 9B, an event such as RLF and an RRC connection re-establishment process in a current LTE protocol may be reused, so that data transmission can be resumed quickly, and UE implementation complexity can be reduced.

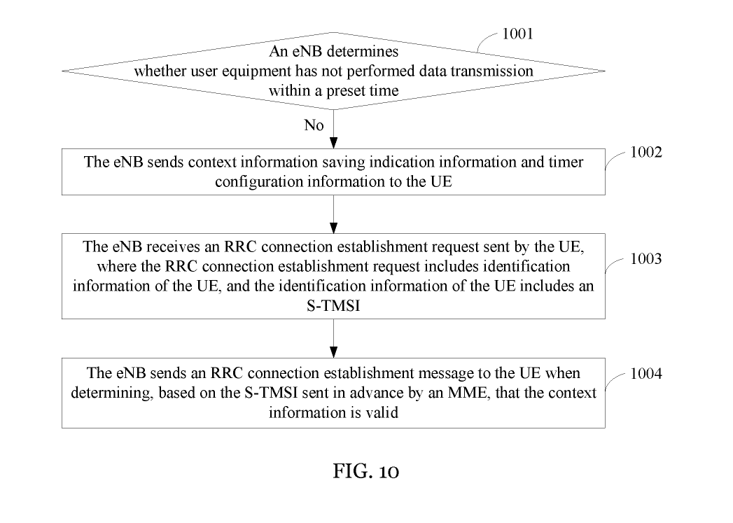

FIG. o10 is a flowchart of Embodiment 6 of a data transmission processing method according to an embodiment of the present disclosure. This embodiment is described from a perspective of a base station eNB. As shown in FIG. 10, the method may include the following steps.

Step 1001. The eNB determines whether user equipment has not performed data transmission within a preset time, and performs step 1002 when the user equipment has not performed data transmission within the preset time.

For a manner in which the eNB determines whether the UE has not transmitted data within a specified time, refer to the embodiment shown in FIG. 1. For example, the determining may be performed when a context information saving request of the UE is received or based on a record of transmission with the UE.

Step 1002. The eNB sends context information saving indication information and timer configuration information to the UE.

The UE may save context information based on the indication information, may determine that the UE is in a state related to triggering of RRC connection re-establishment or triggering of RRC connection establishment, and may trigger an RRC connection re-establishment process or an RRC connection establishment process when there is uplink and/or downlink to-be-transmitted data.

The UE correspondingly may configure and start a timer based on the timer configuration information.

For a specific implementation, refer to the foregoing embodiments, and details are not repeated.

Step 1003. The eNB receives an RRC connection establishment request sent by the UE, where the RRC connection establishment request may include identification information of the UE, and the identification information of the UE may include an S-TMSI.

Step 1004. The eNB sends an RRC connection establishment message to the UE when determining, based on the S-TMSI sent in advance by an MME, that the context information is valid.

In this embodiment, the RRC connection establishment process is described from only an eNB side perspective. After receiving an RRC connection establishment request that may carry the S-TMSI and that may be sent by the UE, the eNB may first determine, based on the S-TMSI of the UE received from the MME, whether the context information of the UE has been locally saved, that is, whether the context information of the UE is valid; and may send an RRC connection establishment message to the UE when determining that the context information of the UE is valid. The RRC connection establishment message may include resumption indication information, and the resumption indication information may be used to instruct the UE to resume data transmission using the saved context information.

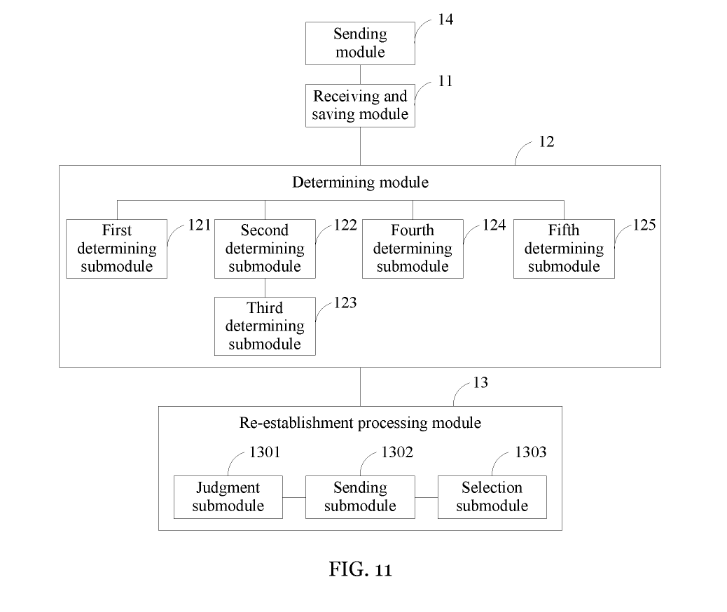

FIG. 11 is a schematic structural diagram of Embodiment 1 of user equipment according to an embodiment of the present disclosure. As shown in FIG. 11, the user equipment may include a receiving and saving module 11, a determining module 12, and a re-establishment processing module 13.

The receiving and saving module 11 may be configured to: receive context information saving indication information sent by a base station, and save context information of the user equipment according to the context information saving indication information.

The determining module 12 may be configured to determine that the user equipment is in a state related to triggering of RRC connection re-establishment or triggering of RRC connection establishment.

The re-establishment processing module 13 may be configured to: trigger an RRC connection re-establishment process or an RRC connection establishment process when the user equipment has uplink and/or downlink to-be-transmitted data, to transmit the to-be-transmitted data using the saved context information and a re-established RRC connection or an established RRC connection.

Optionally, the user equipment further may include a sending module 14.

The sending module 14 may be configured to: when it is determined that no data needs to be transmitted within a first preset time, send a context information saving request to the base station, to cause the base station to save the context information.

The context information saving indication information may be sent by the base station based on the context information saving request, or may be sent by the base station based on a record of data transmission with the user equipment when it is determined that no data transmission is performed with the user equipment within a second preset time. The second preset time may be equal to or may not be equal to the first preset time.

Optionally, the determining module 12 may include a first determining submodule 121.

The first determining submodule 121 may be configured to determine that the user equipment is in a radio link failure RLF state.

Optionally, the determining module 12 may include a second determining submodule 122 and a third determining submodule 123.

The second determining submodule 122 may be configured to determine that the user equipment is in a state of being timing synchronized with the base station.

The third determining submodule 123 may be configured to: when the user equipment has the to-be-transmitted data, determine that the user equipment is in an RLF state.

Optionally, the determining module 12 may include a fourth determining submodule 124.

The fourth determining submodule 124 may be configured to: determine that the user equipment is in an RRC connection re-establishment initialization state, and perform a cell selection or re-selection process based on the RRC connection re-establishment initialization state.

Optionally, the determining module 12 may include a fifth determining submodule 125.

The fifth determining submodule 125 may be configured to: determine that the user equipment is in an RRC connection establishment initialization state and perform a cell selection or re-selection process based on the RRC connection establishment initialization state, or determine that the user equipment is in a cell selection or re-selection process.

Optionally, the re-establishment processing module 13 may include a judgment submodule 1301, a sending submodule 1302, and a selection submodule 1303.

The judgment submodule 1301 may be configured to determine whether a current serving cell of the user equipment meets a preset communication requirement.

The sending submodule 1302 may be configured to: if the current serving cell meets the preset communication requirement, send an RRC connection re-establishment request or an RRC connection establishment request to the base station.

The selection submodule 1303 may be configured to: if the current serving cell does not meet the preset communication requirement, perform a cell selection or re-selection process.

The sending submodule 1302 may be further configured to send an RRC connection re-establishment request or an RRC connection establishment request to the base station when a base station corresponding to a selected cell is the base station.

Optionally, the sending submodule 1302 may be further configured to: when the user equipment has the to-be-transmitted data, send an RRC connection re-establishment request to the base station using a selected cell.

Optionally, the sending submodule 1302 may be further configured to: when the user equipment has the to-be-transmitted data, send an RRC connection establishment request to the base station using a selected cell.

All optional implementations of the embodiment shown in FIG. 11 may be used to implement the technical solution related to the user equipment UE in FIG. 1, or FIG. 6A to FIG. 9B. An implementation principle and a technical effect of the embodiment are similar to those of the user equipment UE in FIG. 1, or FIG. 6A to FIG. 9B, and details are not repeated herein.

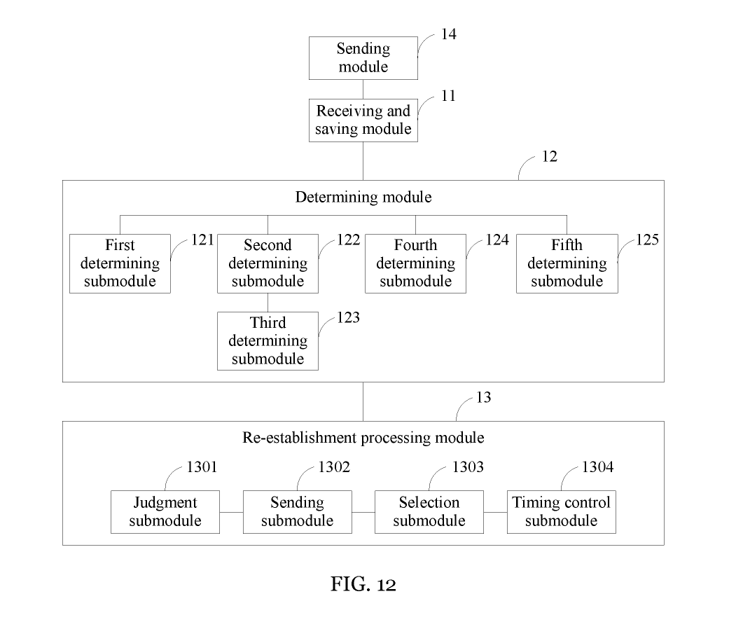

FIG. 12 is a schematic structural diagram of Embodiment 2 of user equipment according to an embodiment of the present disclosure. As shown in FIG. 12, the re-establishment processing module 13 may include a timing control submodule 1304.

The timing control submodule 1304 may be configured to: start a first timer, and after the first timer expires, release the context information.

Optionally, the selection submodule 1303 may be configured to: perform a cell selection or re-selection process within a time period corresponding to the first timer, and select a cell.

The timing control submodule 1304 may be configured to: if no cell is selected within the time period corresponding to the first timer, release the context information.

Optionally, the selection submodule 1303 may be specifically configured to: start a second timer, and within an i^{th} time period corresponding to the second timer, suspend or stop the second timer if a first cell is selected; and after the second timer is suspended or stopped, if the first cell is no longer a proper cell, reset and restart the second timer, so as to select a second cell within an (i+1−n)^{th} time period, where i is an integer ranging from 1 to n, and n is an integer greater than 1.

Optionally, the selection submodule 1303 may be further configured to: perform a cell selection or re-selection process, and if a base station corresponding to a selected cell is different from the base station that sends the context information saving indication information, or a quantity of selected-cell changes is greater than or equal to a preset quantity, determine to trigger an initial RRC connection establishment process when the user equipment has the to-be-transmitted data.

Optionally, the selection submodule 1303 may be further configured to: perform a cell selection or re-selection process, trigger execution of a location update process when it is determined that a track area of a selected cell has changed, and establish a data radio bearer with a new base station in the location update process.

The receiving and saving module 11 may be further configured to: receive, in the location update process or after location update is complete, context information saving indication information sent by the new base station.

The user equipment in the embodiment shown in FIG. 12 may be configured to implement the technical solution related to the user equipment UE in FIG. 2 or FIG. 6A to FIG. 9B. An implementation principle and a technical effect of the user equipment are similar to those of the user equipment UE in FIG. 2 or FIG. 6A to FIG. 9B, and details are not repeated herein.

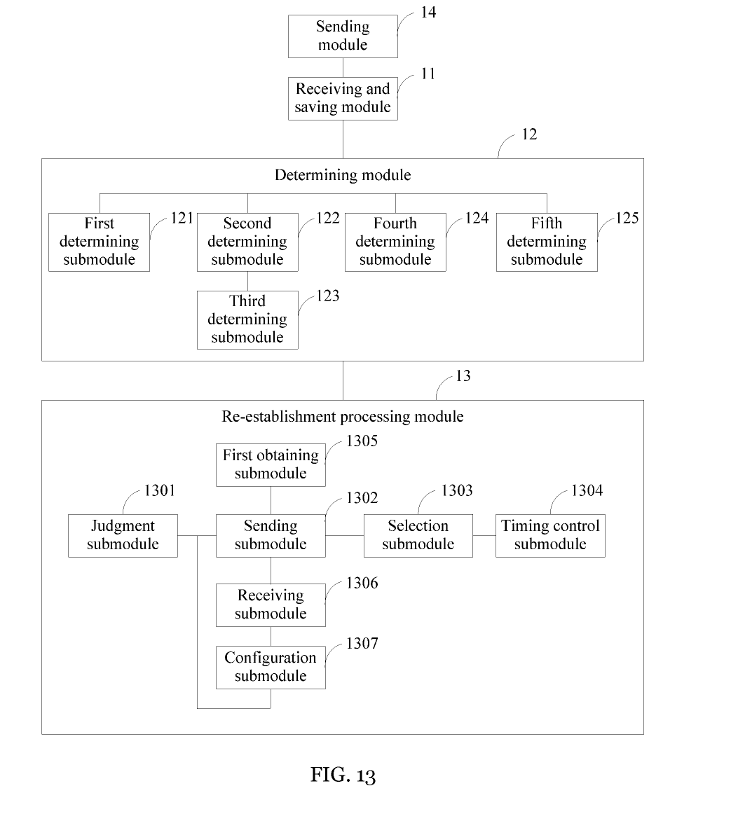

FIG. 13 is a schematic structural diagram of Embodiment 3 of user equipment according to an embodiment of the present disclosure. As shown in FIG. 13, optionally, the re-establishment processing module 13 may include a first obtaining submodule 1305.

The first obtaining submodule 1305 may be configured to obtain uplink timing advance information and/or an uplink transmission resource.

The sending submodule 1302 may be configured to: adjust uplink transmit timing based on the uplink timing advance information, and/or send an RRC connection re-establishment request to the base station using the uplink transmission resource. The RRC connection re-establishment request may include any one of identification information of the user equipment, a short message authentication code for integrity short MAC-I, and re-establishment cause indication information, and the re-establishment cause indication information may be used to instruct the user equipment to resume data transmission using the saved context information.

Optionally, the re-establishment processing module 13 further may include a receiving submodule 1306 and a configuration submodule 1307.

The receiving submodule 1306 may be configured to receive an RRC connection re-establishment message sent by the base station. The connection re-establishment message may include radio resource configuration information and security key information.

The configuration submodule 1307 may be configured to: perform corresponding resource configuration based on the radio resource configuration information, and determine to restore a data radio bearer DRB.

The sending submodule 1302 may be further configured to send, to the base station, an RRC connection re-establishment complete message encrypted based on the security key information. The RRC connection re-establishment complete message may include the to-be-transmitted data.

Optionally, the timing control submodule 1304 may be further configured to: if it is determined that the user equipment is in the RRC connection re-establishment initialization state, when the user equipment has the to-be-transmitted data or the user equipment sends the RRC connection re-establishment request to the base station, start a third timer, and stop the first timer and/or the second timer.

Optionally, the timing control submodule 1304 may be further configured to: if the receiving submodule receives the RRC connection re-establishment message within a time period corresponding to the third timer, stop recording time of the third timer; or if the receiving submodule does not receive the RRC connection re-establishment message within a time period corresponding to the third timer, perform one or more of the following operations: entering an RRC idle state; stopping the first timer; triggering sending of an RRC connection establishment request to the base station corresponding to the selected cell; and triggering cell selection or re-selection, and sending an RRC connection establishment request to the base station corresponding to the selected cell.

Specifically, the first obtaining submodule 1305 may include a judgment unit, a first obtaining unit, and a second obtaining unit.

The judgment unit may be configured to determine whether a current coverage level has changed.

The first obtaining unit may be configured to: when the coverage level has changed, send a random access request to the base station; and receive a random access response message sent by the base station, where the random access response message may include the uplink timing advance information and uplink resource allocation information used to obtain the uplink transmission resource.

The second obtaining unit may be configured to: when the coverage level has not changed, obtain currently locally saved uplink timing advance information as the uplink timing advance information.

The uplink transmission resource may be obtained in any one of the following manners: sending a scheduling request resource to the base station, to obtain the uplink transmission resource; contending for an uplink shared channel resource, to obtain the uplink transmission resource; and obtaining a resource preconfigured for the user equipment by the base station, as the uplink transmission resource.

The judgment unit may be configured to: determine whether a current coverage level has changed, depending on whether a radio resource management RRM measurement result change amount exceeds a preset threshold.

All optional implementations of the embodiment shown in FIG. 13 may be used to implement the technical solution related to the user equipment UE in FIG. 3 and FIG. 4, or FIG. 6A to FIG. 8B. An implementation principle and a technical effect of the embodiment are similar to those of the user equipment UE in FIG. 3 and FIG. 4, or FIG. 6A to FIG. 8B, and details are not repeated herein.

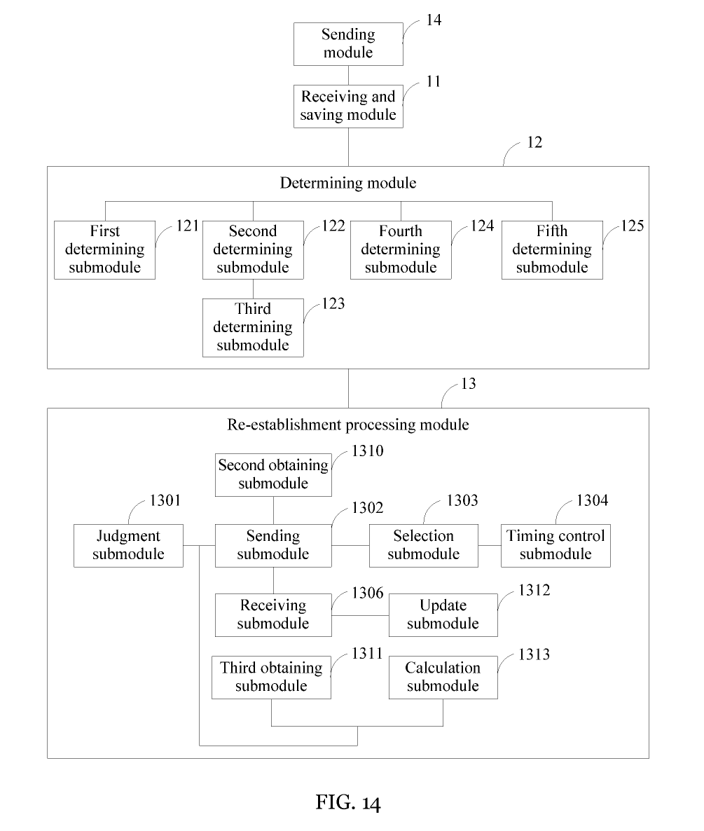

FIG. 14 is a schematic structural diagram of Embodiment 4 of user equipment according to an embodiment of the present disclosure. As shown in FIG. 14, the re-establishment processing module 13 may include: a second obtaining submodule 1310, configured to obtain uplink timing advance information and/or an uplink transmission resource.

The sending submodule 1302 may be further configured to: adjust uplink transmit timing based on the uplink timing advance information, and/or send an RRC connection establishment request to the base station using the uplink transmission resource. The RRC connection establishment request may include identification information of the user equipment.

Optionally, the receiving submodule 1306 may be further configured to: receive an RRC connection establishment message sent by the base station, where the RRC connection establishment message may include resumption indication information, and the resumption indication information may be used to instruct the user equipment to resume data transmission using the saved context information.

The sending submodule 1302 may be further configured to send an RRC connection establishment complete message to the base station.

Specifically, the sending submodule 1302 may be further configured to send the RRC connection establishment complete message to the base station. The RRC connection establishment complete message may include a short MAC-I calculated based on the identification information of the user equipment.

Optionally, the re-establishment processing module 13 further may include a third obtaining submodule 1311.

The third obtaining submodule 1311 may be configured to obtain a security key.

The sending submodule 1302 may be further configured to: encrypt and/or apply integrity protection on the RRC connection establishment complete message based on the security key, and send the RRC connection establishment complete message.

Optionally, the sending submodule 1302 may be further configured to: encrypt and/or apply integrity protection on the RRC connection establishment request based on the security key, and send the RRC connection establishment request.

The third obtaining submodule 1311 may be specifically configured to: obtain a security key in the context information, where the security key may include a message integrity protection key K_{RRCinc}, a message encryption key K_{RRCenc}, and a data encryption key K_{UPenc}.

Further, the receiving submodule 1306 may be further configured to receive security key indication information sent by the base station. The security key indication information may include security key update information.

Correspondingly, the re-establishment processing module 13 further may include an update submodule 1312 and a calculation submodule 1313.

The update submodule 1312 may be configured to update an intermediate key KeNB based on the security key update information.

The calculation submodule 1313 may be configured to: generate a message integrity protection key K_{RRCinc} based on an updated intermediate key KeNB and an integrity protection algorithm, and generate a message encryption key K_{RRCenc} and a data encryption key K_{UPenc} based on the updated intermediate key KeNB and an encryption algorithm.

The security key indication information may be carried in any one of the following messages: a key update indication message, a data transmission indication message, an RRC connection establishment message, and a message carrying the UE context saving indication information.

Specifically, the second obtaining submodule 1310 may include a judgment unit, a first obtaining unit, and a second obtaining unit.

The judgment unit may be configured to determine whether a current coverage level has changed.

The first obtaining unit may be configured to: when the coverage level has changed, send a random access request to the base station; and receive a random access response message sent by the base station, where the random access response message may include the uplink timing advance information and uplink resource allocation information used to obtain the uplink transmission resource.

The second obtaining unit may be configured to: when the coverage level has not changed, obtain currently locally saved uplink timing advance information as the uplink timing advance information.

The uplink transmission resource may be obtained in any one of the following manners: sending a scheduling request resource to the base station, to obtain the uplink transmission resource; contending for an uplink shared channel resource, to obtain the uplink transmission resource; and obtaining a resource preconfigured for the user equipment by the base station, as the uplink transmission resource.

Specifically, the judgment unit may be configured to: determine whether a current coverage level has changed, depending on whether a radio resource management RRM measurement result change amount exceeds a preset threshold.

All optional implementations of the embodiment shown in FIG. 14 may be used to implement the technical solution related to the user equipment UE in FIG. 5 or FIG. 9A and FIG. 9B. An implementation principle and a technical effect of the embodiment are similar to those of the user equipment UE in either FIG. 5 or FIG. 9A and FIG. 9B, and details are not repeated herein.

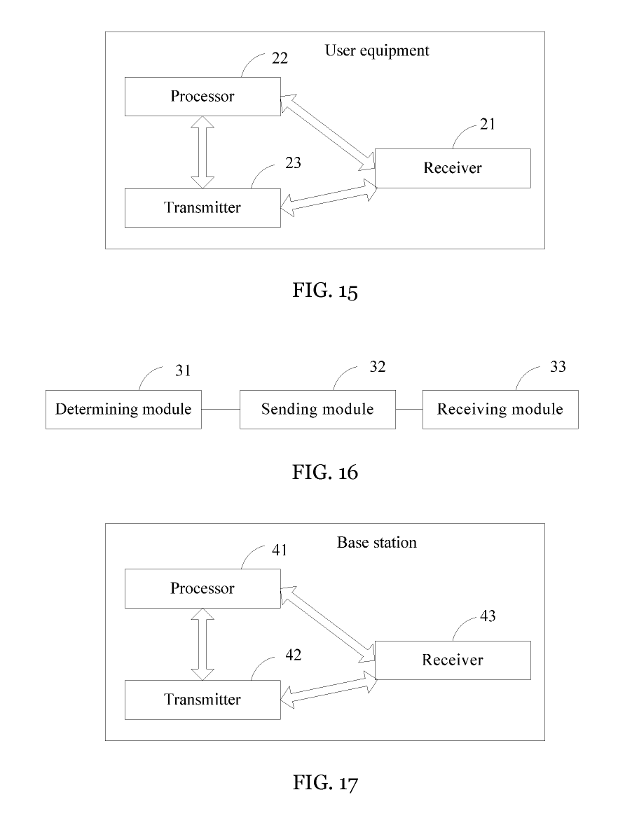

FIG. 15 is a schematic structural diagram of Embodiment 5 of user equipment according to an embodiment of the present disclosure. As shown in FIG. 16, the user equipment may include a receiver 21, a processor 22, and a transmitter 23.

The receiver 21 may be configured to: receive context information saving indication information sent by a base station, and save context information of the user equipment according to the context information saving indication information.

The processor 22 may be configured to determine that the user equipment is in a state related to triggering of RRC connection re-establishment or triggering of RRC connection establishment.

The processor 22 may be configured to: trigger an RRC connection re-establishment process or an RRC connection establishment process when the user equipment has uplink and/or downlink to-be-transmitted data, to transmit the to-be-transmitted data using the saved context information and a re-established RRC connection or an established RRC connection.

Optionally, the processor 22 may be further configured to determine that the user equipment is in a radio link failure RLF state.

Optionally, the processor 22 may be further configured to: determine that the user equipment is in a state of being timing synchronized with the base station; and when the user equipment has the to-be-transmitted data, determine that the user equipment is in an RLF state.

Optionally, the processor 22 may be further configured to: determine that the user equipment is in an RRC connection re-establishment initialization state, and perform a cell selection or re-selection process based on the RRC connection re-establishment initialization state.

Optionally, the processor 22 may be further configured to: determine that the user equipment is in an RRC connection establishment initialization state and perform a cell selection or re-selection process based on the RRC connection establishment initialization state, or determine that the user equipment is in a cell selection or re-selection process.

Optionally, the processor 22 may be further configured to determine whether a current serving cell of the user equipment meets a preset communication requirement.

The user equipment further may include a transmitter 23.

The transmitter 23 may be configured to: if the current serving cell meets the preset communication requirement, send an RRC connection re-establishment request or an RRC connection establishment request to the base station.

The processor 22 may be further configured to: if the current serving cell does not meet the preset communication requirement, perform a cell selection or re-selection process.

The transmitter 23 may be further configured to send an RRC connection re-establishment request or an RRC connection establishment request to the base station when a base station corresponding to a selected cell is the base station.

Optionally, the transmitter 23 may be further configured to: when the user equipment has the to-be-transmitted data, send an RRC connection re-establishment request to the base station using a selected cell.

Optionally, the transmitter 23 may be further configured to: when the user equipment has the to-be-transmitted data, send an RRC connection establishment request to the base station using a selected cell.

Further, the processor 22 may be further configured to: start a first timer, and after the first timer expires, release the context information.

Further, the processor 22 may be further configured to: perform a cell selection or re-selection process within a time period corresponding to the first timer, and select a cell; and release the context information if no cell is selected within the time period corresponding to the first timer to establish or re-establish an RRC connection.

Further, the processor 22 may be further configured to: start a second timer, and within an i^{th} time period corresponding to the second timer, suspend or stop the second timer if a first cell is selected; and after the second timer is suspended or stopped, if the first cell is no longer a proper cell, reset and restart the second timer, so as to select a second cell within an (i+1−n)^{th} time period, where i is an integer ranging from 1 to n, and n is an integer greater than 1.

Further, the processor 22 may be further configured to: obtain uplink timing advance information and/or an uplink transmission resource.

The transmitter 23 may be further configured to: adjust uplink transmit timing based on the uplink timing advance information, and/or send an RRC connection re-establishment request to the base station using the uplink transmission resource. The RRC connection re-establishment request may include any one of identification information of the user equipment, a short message authentication code for integrity short MAC-I, and re-establishment cause indication information, and the re-establishment cause indication information may be used to instruct the user equipment to resume data transmission using the saved context information.

Further, the receiver 21 may be further configured to receive an RRC connection re-establishment message sent by the base station. The connection re-establishment message may include radio resource configuration information and security key information.

The processor 22 may be further configured to: perform corresponding resource configuration based on the radio resource configuration information, and determine to restore a data radio bearer DRB.

Further, the transmitter 23 may be further configured to send, to the base station, an RRC connection re-establishment complete message encrypted based on the security key information. The RRC connection re-establishment complete message may include the to-be-transmitted data.

The transmitter 23 may be further configured to send, to the base station, an RRC connection re-establishment complete message encrypted based on the security key information. The RRC connection re-establishment complete message may include the to-be-transmitted data.

Further, the processor 22 may be further configured to: if it is determined that the user equipment is in the RRC connection re-establishment initialization state, when the user equipment has the to-be-transmitted data or the user equipment sends the RRC connection re-establishment request to the base station, start a third timer, and stop the first timer and/or the second timer.

Further, the processor 22 may be further configured to: if the receiving submodule receives the RRC connection re-establishment message within a time period corresponding to the third timer, stop recording time of the third timer; or if the receiving submodule does not receive the RRC connection re-establishment message within a time period corresponding to the third timer, perform one or more of the following operations: entering an RRC idle state; stopping the first timer; triggering sending of an RRC connection establishment request to the base station corresponding to the selected cell; and triggering cell selection or re-selection, and sending an RRC connection establishment request to the base station corresponding to the selected cell.

Further, the processor 22 may be further configured to: obtain uplink timing advance information and/or an uplink transmission resource.

The transmitter 23 may be further configured to: adjust uplink transmit timing based on the uplink timing advance information, and/or send an RRC connection establishment request to the base station using the uplink transmission resource. The RRC connection establishment request may include identification information of the user equipment.

Further, the receiver 21 may be further configured to: receive an RRC connection establishment message sent by the base station, where the RRC connection establishment message may include resumption indication information, and the resumption indication information may be used to instruct the user equipment to resume data transmission using the saved context information.

The transmitter 23 may be further configured to send an RRC connection establishment complete message to the base station.

Further, the transmitter 23 may be further configured to send the RRC connection establishment complete message to the base station. The RRC connection establishment complete message may include a short MAC-I calculated based on the identification information of the user equipment.

The processor 22 may be further configured to obtain a security key.

The transmitter 23 may be further configured to: encrypt and/or apply integrity protection on the RRC connection establishment complete message based on the security key, and send the RRC connection establishment complete message.

Further, the transmitter 23 may be further configured to: encrypt and/or apply integrity protection on the RRC connection establishment request based on the security key, and send the RRC connection establishment request.

Further, the processor 22 may be further configured to obtain a security key in the context information. The security key may include a message integrity protection key K_{RRCinc}, a message encryption key K_{RRCenc}, and a data encryption key K_{UPenc}.

The receiver 21 may be further configured to receive security key indication information sent by the base station. The security key indication information may include security key update information.

The processor 22 may be further configured to: update an intermediate key KeNB based on the security key update information; and generate a message integrity protection key K_{RRCinc} based on an updated intermediate key KeNB and an integrity protection algorithm, and generate a message encryption key K_{RRCenc} and a data encryption key K_{UPene} based on the updated intermediate key KeNB and an encryption algorithm.

The security key indication information may be carried in any one of the following messages: a key update indication message, a data transmission indication message, an RRC connection establishment message, and a message carrying the UE context saving indication information.

Further, the processor 22 may be further configured to: determine whether a current coverage level has changed.

The transmitter 23 may be further configured to send a random access request to the base station when the coverage level has changed.

The receiver 21 may be further configured to receive a random access response message sent by the base station. The random access response message may include the uplink timing advance information and uplink resource allocation information used to obtain the uplink transmission resource.

The transmitter 23 may be further configured to: when the coverage level has not changed, obtain currently locally saved uplink timing advance information as the uplink timing advance information.

The processor 22 may be further configured to obtain the uplink transmission resource in any one of the following manners: sending a scheduling request resource to the base station, to obtain the uplink transmission resource; contending for an uplink shared channel resource, to obtain the uplink transmission resource; and obtaining a resource preconfigured for the user equipment by the base station, as the uplink transmission resource.

Further, the processor 22 may be further configured to: determine whether a current coverage level has changed, depending on whether a radio resource management RRM measurement result change amount exceeds a preset threshold.

The transmitter 23 may be further configured to: when it is determined that no data needs to be transmitted within a first preset time, send a context information saving request to the base station, to cause the base station to save the context information.

Specifically, the context information saving indication information may be sent by the base station based on the context information saving request, or may be sent by the base station based on a record of data transmission with the user equipment when it is determined that no data transmission is performed with the user equipment within a second preset time. The second preset time may be equal to or may not be equal to the first preset time.

Further, the receiver 21 may be further configured to receive configuration information of a fourth timer sent by the base station. The fourth timer may be configured to time validity of a security key in the context information.

Specifically, the context information saving indication information may be included in any one of the following indication messages: a context information saving indication message, an RRC connection suspension indication message, and an RRC connection release indication message.

Further, the processor 22 may be further configured to: perform a cell selection or re-selection process, and if a base station corresponding to a selected cell is different from the base station that sends the context information saving indication information, or a quantity of selected-cell changes is greater than or equal to a preset quantity, determine to trigger an initial RRC connection establishment process when the user equipment has the to-be-transmitted data.

Further, the processor 22 may be further configured to: perform a cell selection or re-selection process, trigger execution of a location update process when it is determined that a track area of a selected cell has changed, and establish a data radio bearer with a new base station in the location update process.

Further, the receiver 21 may be further configured to receive, in the location update process or after location update is complete, context information saving indication information sent by the new base station.

The user equipment provided in this embodiment may be configured to implement the technical solutions related to the user equipment in the foregoing embodiments. An implementation principle and a technical effect of the user equipment are similar to those of the user equipment in the foregoing embodiments, and details are not repeated herein.

FIG. 16 is a schematic structural diagram of Embodiment 1 of a base station according to an embodiment of the present disclosure. As shown in FIG. 16, the base station may include a determining module 31 and a sending module 32.

The determining module 31 may be configured to determine whether user equipment has not performed data transmission within a preset time.

The sending module 32 may be configured to: when the determining module determines that the user equipment has not performed data transmission within the preset time, send context information saving indication information to the user equipment, so that the user equipment saves context information; determine that the user equipment is in a state related to triggering of RRC connection re-establishment or triggering of RRC connection establishment; and when there is uplink and/or downlink to-be-transmitted data, trigger an RRC connection re-establishment process or an RRC connection establishment process.

Optionally, the sending module 32 may be further configured to: send timer configuration information to the user equipment when the determining module determines that the user equipment has not performed data transmission within the preset time, where the timer configuration information may include timer configuration information indicating validity of a security key in the context information and timer configuration information indicating validity of the context information.

Further, the base station further may include a receiving module 33.

The receiving module 33 may be configured to receive an RRC connection establishment request sent by the user equipment, where the RRC connection establishment request may include identification information of the user equipment, and the identification information of the user equipment may include an S-TMSI.

The sending module 32 may be further configured to send an RRC connection establishment message to the user equipment when the determining module determines, based on the S-TMSI sent in advance by a mobility management entity MME, that the context information is valid. The RRC connection establishment message may include resumption indication information, and the resumption indication information may be used to instruct the user equipment to resume data transmission using the saved context information.

The base station provided in this embodiment may be configured to implement the technical solution of the embodiment shown in FIG. 10. An implementation principle and a technical effect of the base station are similar to those of the embodiment shown in FIG. 10, and details are not repeated.

FIG. 17 is a schematic structural diagram of Embodiment 2 of a base station according to an embodiment of the present disclosure. As shown in FIG. 17, the base station may include: a processor 41, configured to determine whether user equipment has not performed data transmission within a preset time; and a transmitter 42, configured to: when the determining module determines that the user equipment has not performed data transmission within the preset time, send context information saving indication information to the user equipment, so that the user equipment saves context information; determine that the user equipment is in a state related to triggering of RRC connection re-establishment or triggering of RRC connection establishment; and when there is uplink and/or downlink to-be-transmitted data, trigger an RRC connection re-establishment process or an RRC connection establishment process.

Optionally, the transmitter 42 may be further configured to: send timer configuration information to the user equipment when the determining module determines that the user equipment has not performed data transmission within the preset time, where the timer configuration information may include timer configuration information indicating validity of a security key in the context information and timer configuration information indicating validity of the context information.

Further, the base station may further include: a receiver 43, configured to receive an RRC connection establishment request sent by the user equipment, where the RRC connection establishment request may include identification information of the user equipment, and the identification information of the user equipment may include an S-TMSI.

The transmitter 42 may be further configured to send an RRC connection establishment message to the user equipment when the determining module determines, based on the S-TMSI sent in advance by a mobility management entity MME, that the context information is valid. The RRC connection establishment message may include resumption indication information, and the resumption indication information may be used to instruct the user equipment to resume data transmission using the saved context information.

The base station provided in this embodiment may be configured to implement the technical solution of the embodiment shown in FIG. 10. An implementation principle and a technical effect of the base station are similar to those of the embodiment shown in FIG. 10, and details are not repeated.

It should be understood that in the foregoing user equipment and base station embodiments, the processor may be a central processing unit (CPU), or may be another general purpose processor, a digital signal processor (DSP), an application specific integrated circuit (ASIC), or the like. The general purpose processor may be a microprocessor, or the processor may be any normal processor, or the like. The steps of the method disclosed with reference to the embodiments of the present disclosure may be directly performed by a hardware processor, or may be performed using a combination of hardware in the processor and a software module.

Persons of ordinary skill in the art may understand that all or some of the steps of the method embodiments may be implemented by a program instructing relevant hardware. The program may be saved in a computer-readable storage medium. When the program is executed, the steps of the methods in the embodiments are performed. The storage medium may include: a read-only memory (ROM), a RAM, a flash memory, a hard disk, a solid state disk, a magnetic tape, a floppy disk, an optical disc, and any combination thereof. Finally, it should be noted that the foregoing embodiments are merely intended for describing the technical solutions of the present disclosure, but not for limiting the present disclosure. Although the present disclosure is described in detail with reference to the foregoing embodiments, persons of ordinary skill in the art should understand that they may still make modifications to the technical solutions described in the foregoing embodiments or make equivalent replacements to some or all technical features thereof, without departing from the scope of the technical solutions of the embodiments of the present disclosure.

What is claimed is:

1. A method, comprising:
receiving, by a user equipment, context information saving indication information sent by a base station, wherein the user equipment is served by the base station;
saving, by the user equipment, context information of the user equipment according to the context information saving indication information;
determining, by the user equipment, that the user equipment is in a state related to triggering of radio resource control (RRC) connection re-establishment or triggering of RRC connection establishment; and
when the user equipment needs to perform data transmission with the base station, triggering, by the user equipment, an RRC connection re-establishment process or an RRC connection establishment process, and performing the data transmission with the based station on a re-established RRC connection or an established RRC connection according to the saved context information.

2. The method according to claim 1, wherein determining that the user equipment is in the state related to triggering of RRC connection re-establishment or triggering of RRC connection establishment comprises:
determining that the user equipment is in an RRC connection re-establishment initialization state; and
performing a cell selection or re-selection process based on the RRC connection re-establishment initialization state.

3. The method according to claim 1, wherein determining that the user equipment is in the state related to triggering of RRC connection re-establishment or triggering of RRC connection establishment comprises:
determining that the user equipment is in an RRC connection establishment initialization state; and
performing a cell selection or re-selection process based on the RRC connection establishment initialization state.

4. The method according to claim 1, wherein triggering the RRC connection re-establishment process or the RRC connection establishment process comprises:
when the user equipment has to-be-transmitted data for the data transmission with the based station, sending an RRC connection re-establishment request to the base station using a selected cell.

5. The method according to claim 1, further comprising:
when the user equipment needs to perform data transmission with the base station, starting a first timer before triggering the RRC connection re-establishment process or the RRC connection establishment process; and
after the first timer has expired, releasing the context information.

6. The method according to claim 1, wherein triggering the RRC connection re-establishment process or the RRC connection establishment process comprises:
obtaining uplink timing advance information and an uplink transmission resource;
adjusting uplink transmit timing according to the uplink timing advance information; and
sending an RRC connection re-establishment request to the base station using the uplink transmission resource, wherein the RRC connection re-establishment request comprises: identification information of the user equipment, a short message authentication code for integrity short MAC-I, or re-establishment cause indication information, and wherein the re-establishment cause indication information instructs the user equipment to resume data transmission using the saved context information.

7. The method according to claim 1, wherein triggering the RRC connection establishment process comprises:
obtaining uplink timing advance information an uplink transmission resource;
adjusting uplink transmit timing according to the uplink timing advance information; and
sending an RRC connection establishment request to the base station using the uplink transmission resource, wherein the RRC connection establishment request comprises identification information of the user equipment.

8. The method according to claim 7, further comprising:
receiving an RRC connection establishment message sent by the base station, wherein the RRC connection establishment message comprises resumption indication information, and the resumption indication information instructs the user equipment to resume data transmission using the saved context information; and
sending an RRC connection establishment complete message to the base station.

9. The method according to claim 7, wherein sending the RRC connection establishment request to the base station comprises:
obtaining a security key;
encrypting or applying integrity protection on the RRC connection establishment request according to the security key; and
sending the RRC connection establishment request.

10. A user equipment, comprising:
a receiver, configured to receive context information saving indication information sent by a base station;
a processor; and
a computer-readable storage medium storing a program to be executed by the processor, the program including instructions for:
saving context information of the user equipment according to the context information saving indication information;
determining that the user equipment is in a state related to triggering of radio resource control (RRC) connection re-establishment or triggering of RRC connection establishment; and
when the user equipment needs to perform data transmission with the base station, triggering an RRC connection re-establishment process or an RRC connection establishment process, and performing the data transmission with the based station using the saved context information and a re-established RRC connection or an established RRC connection.

11. The user equipment according to claim 10, wherein determining that the user equipment is in the state related to triggering of RRC connection re-establishment or triggering of RRC connection establishment comprises:
determining that the user equipment is in an RRC connection re-establishment initialization state, and
performing a cell selection or re-selection process based on the RRC connection re-establishment initialization state.

12. The user equipment according to claim 10, wherein determining that the user equipment is in the state related to triggering of RRC connection re-establishment or triggering of RRC connection establishment comprises:
determining that the user equipment is in an RRC connection establishment initialization state, and
performing a cell selection or re-selection process based on the RRC connection establishment initialization state, or determine that the user equipment is in a cell selection or re-selection process.

13. The user equipment according to claim 10, wherein triggering the RRC connection re-establishment process or the RRC connection establishment process comprises:
when the user equipment needs to perform data transmission with the base station, sending an RRC connection re-establishment request to the base station using a selected cell.

14. The user equipment according to claim 10, wherein the program further includes instructions for:
when the user equipment needs to perform data transmission with the base station, starting a first timer before triggering an RRC connection re-establishment process or an RRC connection establishment process; and
after the first timer has expired, releasing the context information.

15. The user equipment according to claim 10, wherein triggering the RRC connection re-establishment process or the RRC connection establishment process comprises:
obtaining uplink timing advance information and an uplink transmission resource;
adjusting uplink transmit timing according to the uplink timing advance information; and
wherein the user equipment further comprises:
a transmitter, configured to send an RRC connection re-establishment request to the base station using the uplink transmission resource, wherein the RRC connection re-establishment request comprises: identification information of the user equipment, a short message authentication code for integrity short MAC-I, or re-establishment cause indication information, and wherein the re-establishment cause indication information instructs the user equipment to resume data transmission according to the saved context information.

16. The user equipment according to claim 10, wherein triggering the RRC connection establishment process comprises:
obtaining uplink timing advance information and an uplink transmission resource;
adjusting uplink transmit timing based on the uplink timing advance information; and
wherein the user equipment further comprises:
a transmitter, configured to send an RRC connection establishment request to the base station using the uplink transmission resource, wherein the RRC connection establishment request comprises identification information of the user equipment.

17. The user equipment according to claim 16, wherein the receiver is further configured to receive an RRC connection establishment message sent by the base station, wherein the RRC connection establishment message comprises resumption indication information, and the resumption indication information instructs the user equipment to resume data transmission using the saved context information; and
wherein the transmitter is further configured to send an RRC connection establishment complete message to the base station.

18. The user equipment according to claim 16, wherein sending the RRC connection establishment request to the base station comprises:
sending the RRC connection establishment request by applying integrity protection according to a security key.

19. A base station, comprising:
a transmitter;
a processor; and
a computer-readable storage medium storing a program to be executed by the processor, the program including instructions for:
determining whether user equipment has not performed data transmission within a preset time duration;
in response to determining that the user equipment has not performed data transmission within the preset time duration, sending, by the transmitter, context information saving indication information to the user equipment, causing the user equipment to save context information, and further causing the user equipment to determine that the user equipment is in a state related to triggering of RRC connection re-establishment or triggering of RRC connection establishment; and
performing an RRC connection re-establishment process or an RRC connection establishment process with the user equipment, when the user equipment needs to perform data transmission with the base station.

20. The base station of claim 19, wherein the program further includes instructions for:
in response to determining that the user equipment has not performed data transmission within the preset time duration, sending, by the transmitter, timer configuration information to the user equipment, wherein the timer configuration information comprises timer configuration information indicating validity of a security key in the context information and timer configuration information indicating validity of the context information.
